(19) United States
(12) Patent Application Publication
(10) Pub. No.: US 2024/0406996 A1
(43) Pub. Date: Dec. 5, 2024

(54) EFFICIENT RESOURCE ALLOCATION AND UTILIZATION IN COORDINATED-TDMA TRANSMISSION

(71) Applicant: NEWRACOM, Inc., Irvine, CA (US)

(72) Inventors: Si-Chan NOH, Seoul (KR); Joonsoo LEE, Seoul (KR)

(73) Assignee: NEWRACOM, Inc., Irvine, CA (US)

(21) Appl. No.: 18/676,268

(22) Filed: May 28, 2024

Related U.S. Application Data
(60) Provisional application No. 63/505,047, filed on May 30, 2023.

(51) Int. Cl. H04W 74/0808; H04B 7/26

(52) U.S. Cl. CPC H04W 74/0808; H04B 7/2656

(57) ABSTRACT

A new enhanced Multi-User (MU) Request-to-Send (RTS) Transmit Opportunity Sharing (TXS) frame and solutions for handling unavailable resource units (RUS) at a shared access point (AP) side. A sharing AP can allocate a portion of its RUs and TXOP to shared APs, facilitating C-TDMA coordination and reducing resource waste. The disclosed solutions focus on efficiently handling unavailable RUs at the shared AP side during the allocated TXOP sharing time. When a shared AP cannot fully utilize the allocated RUs due to interference, it can return the interfered RUs to the sharing AP or assign them to another shared AP. By dynamically managing and reallocating interfered RUs, the disclosed solutions optimize resource utilization, minimize waste, and increase overall system throughput in high-density wireless networks.

### CROSS-REFERENCE TO RELATED APPLICATION

This application claims the benefit of U.S. Provisional Application No. 63/505,047 filed May 30, 2023, the entire contents of which is hereby incorporated by reference.

### TECHNICAL FIELD

The present disclosure generally relates to wireless communications, and more specifically, relates to efficient resource allocation and utilization in Coordinated-Time Division Multiple Access (C-TDMA) transmission.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The 802.11 family of standards has evolved over time to accommodate higher data rates, improved security, and better performance in different environments. Some of the most widely used standards include 802.11a, 802.11b, 802.11g, 802.11n, 802.11ac, and the latest 802.11ax (also known as “Wi-Fi 6”). These standards specify the modulation techniques, channel bandwidths, and other technical aspects that ensure interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network with a basic service set that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates inter-frame space relationships, in accordance with some embodiments of the present disclosure.

FIG. 5 illustrates a carrier sense multiple access/collision avoidance-based frame transmission procedure, in accordance with some embodiments of the present disclosure.

FIG. 6 is a table of various characteristics of several wireless networking standards, in accordance with some embodiments of the present disclosure.

FIG. 7 is a table of various fields of an extremely high throughput physical protocol data unit frame, in accordance with some embodiments of the present disclosure.

FIG. 8 illustrates an example of a user information subfield of an enhanced Multi-User (MU) Request-to-Send (RTS) Transmit Opportunity Sharing (TXS) trigger frame, in accordance with some embodiments of the present disclosure.

FIG. 9 illustrates an example of Resource Unit (RU) allocation when a sharing access point transmits an enhanced MU-RTS TXS trigger frame to a shared access point, in accordance with some embodiments of the present disclosure.

FIG. 10 illustrates an example of a wireless network topology encompassing multiple access points and stations including the sharing access point and the shared access point, in accordance with some embodiments of the present disclosure.

FIG. 11 illustrates an example frame exchange sequence involving the sharing access point and the shared access point, in accordance with some embodiments of the present disclosure.

FIG. 12 illustrates an example wireless network topology in which the sharing access point transmits the enhanced MU-RTS TXS trigger frame to the shared access point, in accordance with some embodiments of the present disclosure.

FIG. 13 illustrates an example wireless network topology in which the shared access point has fully decoded the enhanced MU-RTS TXS trigger frame transmitted by the sharing access point, in accordance with some embodiments of the present disclosure.

FIG. 14 illustrates an example of RU allocation when the shared access point has fully decoded the enhanced MU-RTS TXS trigger frame transmitted by the sharing access point, in accordance with some embodiments of the present disclosure.

FIG. 15 illustrates an example of RU allocation when the shared access point has fully decoded the enhanced MU-RTS TX S trigger frame transmitted by the sharing access point, in accordance with some embodiments of the present disclosure.

FIG. 16 illustrates an example frame exchange sequence involving the sharing access point, the shared access point, and another shared access point, in accordance with some embodiments of the present invention.

FIG. 17 illustrates a first solution method performed by the shared access point for efficient resource allocation and utilization in Coordinated-Time Division Multiple Access (C-TDMA) transmission, in accordance with some embodiments of the present invention.

FIG. 18 illustrates a second solution method performed by the shared access point for efficient resource allocation and utilization in Coordinated-Time Division Multiple Access (C-TDMA) transmission, in accordance with some embodiments of the present invention.

FIG. 19 illustrates an example of determining the remaining allocation duration at the shared AP to include in the enhanced MU-RTS TXS trigger frame sent to the sharing AP when returning the interfered RU to the sharing AP, in accordance with some embodiments of the present invention.

### DETAILED DESCRIPTION

The present disclosure generally relates to wireless communications, and more specifically, relates to efficient resource allocation and utilization in Coordinated-Time Division Multiple Access (C-TDMA) transmission.

The IEEE 802.11be standard and its future iterations aim to improve spectral efficiency in high-density network scenarios by incorporating various Multi-AP coordination schemes. These schemes include Coordinated-Time Division Multiple Access (C-TDMA), Coordinated-Orthogonal Frequency Division Multiple Access (C-OFDMA), Coordinated-beamforming (C-BF), Coordinated-Nulling, and joint transmission (JTX). However, the current IEEE 802.11 standard lacks a well-defined mechanism for Access Points (APs) participating in C-TDMA to share information effectively. Specifically, there is a need for a protocol that allows APs to solicit C-TDMA participation from other APs and return any unused time from the shared AP to the sharing AP. Addressing this issue is useful for optimizing resource utilization and enhancing the overall performance of the wireless network.

The disclosed solution addresses this problem by introducing two components: (1) a new enhanced MU-RTS TXS trigger frame and (2) a method for returning unavailable Resource Units (RUs) at the shared AP side. The enhanced MU-RTS TXS trigger frame enables the initiation of the C-TDMA mechanism between APs, minimizing the waste of allocated Resource Units (Rus). This frame allows a sharing AP to allocate a portion of its RUs and obtained Transmit Opportunity (TXOP) to other shared APs, facilitating efficient resource sharing in the network.

Furthermore, the disclosed solution includes a method for handling unavailable RUs at the shared AP side during the allocated TXOP sharing time. This method aims to reduce the waste of allocated RUs, ensuring that resources are utilized effectively. By implementing this solution, the system can support the C-TDMA scheme beyond the IEEE 802.11be standard, enhancing the overall network performance and spectral efficiency in high-density scenarios.

In an embodiment, the disclosed solution encompasses a method performed at a wireless device operating as a shared access point in a wireless network involves several steps. First, the shared access point wirelessly receives a first trigger frame sent by a sharing access point, which allocates a portion of the sharing access point's transmit opportunity to the shared access point. Upon receiving the first trigger frame, the shared access point identifies an interfered resource unit among the plurality of resource units allocated to it by the sharing access point.

Next, the shared access point generates a second trigger frame to return the interfered resource unit to the sharing access point. This second trigger frame specifically indicates the interfered resource unit that the shared access point wishes to return.

Finally, the shared access point wirelessly transmits the second trigger frame to the sharing access point, effectively returning the interfered resource unit. This process allows the shared access point to communicate the presence of interference on a specific resource unit and return it to the sharing access point for potential reallocation or utilization by other devices in the network.

In an embodiment, the disclosed solution encompasses a method performed at a wireless device operating as a first shared access point in a wireless network. Initially, the first shared access point wirelessly receives a first trigger frame sent by a sharing access point, which allocates a portion of the sharing access point's transmit opportunity to the first shared access point. Upon receiving the first trigger frame, the first shared access point determines a particular resource unit, among the plurality of resource units allocated to it by the sharing access point, that is interfered with by one or more overlapping basic service sets at both the sharing access point and the first shared access point.

Instead of returning the interfered resource unit to the sharing access point, the first shared access point generates a second trigger frame to allocate the particular resource unit to a second shared access point in the wireless network. The second trigger frame specifically indicates the particular resource unit that the first shared access point wishes to allocate to the second shared access point.

Lastly, the first shared access point wirelessly transmits the second trigger frame to the second shared access point, effectively allocating the particular resource unit to the second shared access point. This process enables the first shared access point to assign an interfered resource unit, which is not usable at both the sharing access point and the first shared access point, to another shared access point in the network that may be able to utilize it more effectively.

For sake of illustration, various embodiments are primarily described herein in the context of wireless networks based on Institute of Electrical and Electronics Engineers (IEEE) 802.11 standards using terminology thereof. However, embodiments are not limited thereto. Those skilled in the relevant art will appreciate that the techniques disclosed herein can be used in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

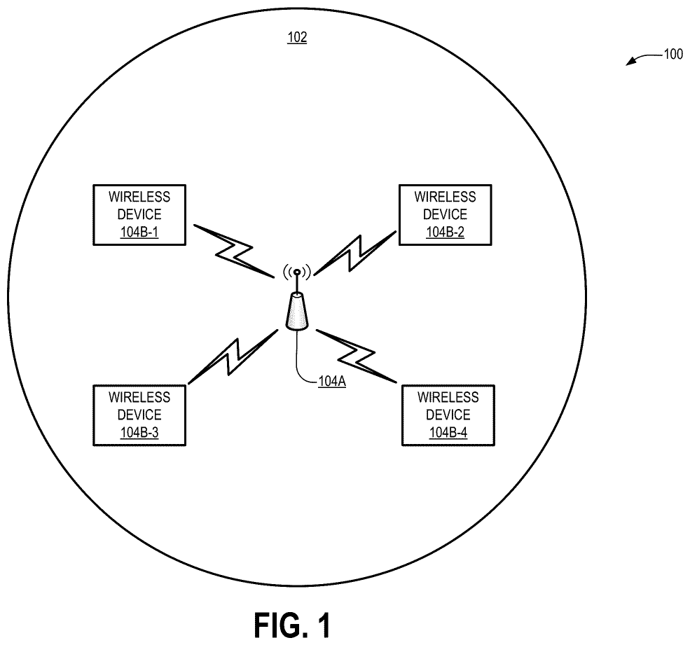

FIG. 1 depicts a wireless local area network 100 (WLAN 100) with a basic service set (BSS) 102. The BSS 102 comprises multiple wireless devices 104 (also known as WLAN devices 104). Each wireless device 104 is equipped with a medium access control (MAC) layer and a physical (PHY) layer, conforming to the IEEE 802.11 standard, which may include any of its amendments (e.g., 802.11a/b/g/n/p/ac/ax/bd/be and beyond).

In one embodiment, the medium access control (MAC) layer of a wireless device 104 can initiate the transmission of a frame to another wireless device 104 by passing a PHY-TXSTART.request (TXVECTOR) to the physical (PHY) layer. The TXVECTOR specifies parameters for generating and/or transmitting the corresponding frame. Likewise, the PHY layer of a receiving wireless device can generate an RXVECTOR, which includes parameters of the received frame, and pass it to the MAC layer for processing.

The group of wireless devices 104 may include a wireless device 104A that serves as an access point, sometimes referred to as an “access point station” or “AP STA,” and other wireless devices 104B1-104B4 that function as non-access point stations, often called “non-AP STAs.”

Alternatively, in an ad-hoc networking environment, all devices in the group, 104, might be non-access point stations. Typically, both the access point station (e.g., wireless device 104A) and the non-access point stations (e.g., wireless devices 104B1-104B4) are collectively considered stations. However, for simplicity in this description, the term “station” may sometimes only refer to non-access point stations. While this example shows four non-access point stations (wireless devices 104B-1 through 104B-4), the wireless local area network (WLAN) 100 can accommodate any number of non-access point stations (e.g., one or more wireless devices 104B).

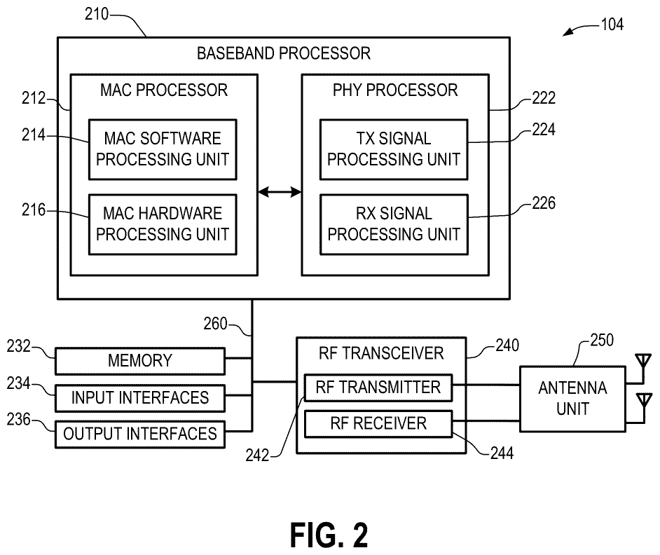

FIG. 2 presents a schematic block diagram of a wireless device 104, according to an embodiment. This wireless device 104 could be either the wireless device 104A (e.g., the access point of wireless local area network (WLAN) 100) or any of the wireless devices 104B-1 through 104B-4 depicted in FIG. 1. The wireless device 104 comprises a baseband processor 210, a radio frequency (RF) transceiver 240 (RF transceiver 240), an antenna unit 250, a storage device (e.g., memory) 232, one or more input interfaces 234, and one or more output interfaces 236. The baseband processor 210, the storage device 232, the input interfaces 234, the output interfaces 236, and the RF transceiver 240 are interconnected via a bus 260.

The baseband processor 210 is responsible for baseband signal processing and encompasses a medium access control (MAC) processor 212 (MAC processor 212) and a physical (PHY) processor 222 (PHY processor 222). It may access memory 232, which can be a non-transitory computer-readable medium containing software (e.g., programmable instructions) and data.

In an embodiment, the MAC processor 212 comprises a MAC software processing unit 214 and a MAC hardware processing unit 216. The MAC software processing unit 214 executes MAC software to perform a first set of functions of the MAC layer, which can be part of the software stored in storage device 232. Conversely, the MAC hardware processing unit 216 realizes a second set of MAC layer functions through specialized hardware. However, the configuration of the MAC processor 212 is not limited to these arrangements. For instance, it may be designed to execute both sets of functions entirely in software or entirely in hardware, depending on the specific implementation.

The PHY processor 222 comprises a transmitting (TX) signal processing unit (SPU) 224 (TxSPU 224) and a receiving (RX) SPU 226 (RxSPU 226). It executes a variety of functions associated with the physical (PHY) layer, which can be carried out in software, hardware, or a mix of both, depending on the implementation.

Functions performed by the TxSPU 224 may include, but are not limited to, forward error correction (FEC) encoding, parsing streams into one or more spatial streams, diversity encoding of these spatial streams into a multitude of space-time streams, spatial mapping of space-time streams to transmit chains, inverse Fourier transform computation, and cyclic prefix insertion to establish a guard interval. Conversely, the RxSPU 226 may handle functions that are essentially the inverses of those performed by the TxSPU 224, such as guard interval removal, Fourier transform computation, among others.

The RF transceiver 240 comprises an RF transmitter 242 and an RF receiver 244. It is designed to transmit information (referred to as first information) received from the baseband processor 210 to the wireless local area network (WLAN) 100 (for example, to another wireless device 104 within the WLAN 100) and to relay information (referred to as second information) received from the WLAN 100 (for example, from another wireless device 104 of the WLAN 100) back to the baseband processor 210.

The antenna unit 250 comprises one or more antennas. For applications utilizing multiple-input, multiple-output (MIMO) or multi-user multiple-input, multiple-output (MU-MIMO), the antenna unit 250 may feature a plurality of antennas. In certain embodiments, these antennas can function as part of a beamforming array. Additionally, the antennas within the antenna unit 250 can be either directional, with options for fixed or steerable orientations.

Input interfaces 234 receive information from a user, while the output interfaces 236 convey information to the user. The input interfaces 234 may encompass one or more of the following: a keyboard, keypad, mouse, touchscreen, microphone, among others. Similarly, the output interfaces 236 may include one or more of the following: a display device, touchscreen, speaker, among others.

As outlined in this document, numerous functions of the wireless local area network (WLAN) device 104 can be realized through either hardware or software. The decision to implement certain functions in software and others in hardware is influenced by various design constraints. These constraints may encompass aspects such as design and manufacturing costs, time-to-market objectives, power consumption considerations, and the availability of semiconductor technology, among others.

As described herein, a wide variety of electronic devices, circuits, firmware, software, and combinations thereof may be used to implement the functions of the components of the wireless local area network (WLAN) device 104. Furthermore, the WLAN device 104 may include other components, such as application processors, storage interfaces, clock generator circuits, power supply circuits, and the like, which have been omitted in the interest of brevity.

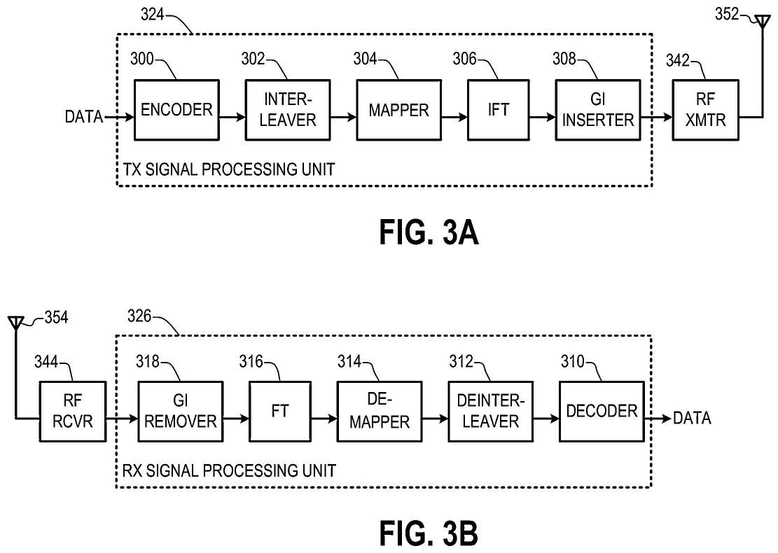

FIG. 3A illustrates components of a wireless local area network (WLAN) device 104 configured to transmit data according to an embodiment, including a transmitting (TX) signal processing unit (SPU) 324 (TxSPU 324), a radio frequency (RF) transmitter 342 (RF transmitter 342), and an antenna 352. In an embodiment, the TxSPU 324, the RF transmitter 342, and the antenna 352 correspond to the TxSPU 224, the RF transmitter 242, and an antenna of the antenna unit 250 of FIG. 2, respectively.

The TxSPU 324 comprises an encoder 300, an interleaver 302, a mapper 304, an inverse Fourier transformer 306, and a guard interval inserter 308.

Encoder 300 receives input data and encodes it. In one embodiment, the encoder 300 features a forward error correction (FEC) encoder, which may encompass a binary convolutional code encoder followed by a puncturing device. Alternatively, the FEC encoder may utilize a low-density parity-check encoder.

The TxSP 324 may also incorporate a scrambler to scramble the input data before encoding by the encoder 300, aiming to minimize the likelihood of prolonged sequences of 0s or 1s. When binary convolutional code encoding is executed by the encoder 300, the TxSP 324 might include an encoder parser to demultiplex the scrambled bits across multiple binary convolutional code encoders. However, if the encoder utilizes low-density parity-check encoding, the TxSP 324 may forego the use of the encoder parser.

The interleaver 302 interleaves the bits of each stream output from the encoder 300, altering their order. The interleaver 302 applies interleaving specifically when the encoder 300 performs binary convolutional code encoding. In cases where binary convolutional code encoding is not used, it may pass the stream output from the encoder 300 without modifying the bit order.

Mapper 304 converts the sequence of bits output from the interleaver 302 into constellation points. When the encoder 300 uses low-density parity-check encoding, the mapper 304 may additionally execute low-density parity-check tone mapping, alongside constellation mapping.

When the TxSP 324 is engaged in multiple-input, multiple-output (MIMO) or multi-user multiple-input, multiple-output (MU-MIMO) transmissions, it may incorporate multiple interleavers 302 and mappers 304, corresponding to the number of spatial streams involved in the transmission. Additionally, the TxSP 324 might feature a stream parser to segment the encoder 300's output into blocks, which are then distributed to different interleavers 302 or mappers 304. It may also include a space-time block code encoder to disperse the constellation points across the spatial streams into a set number of space-time streams, and a spatial mapper tasked with assigning these space-time streams to transmit chains. This spatial mapper could employ strategies such as direct mapping, spatial expansion, or beamforming for optimal transmission.

The inverse Fourier transform 306 transforms a block of constellation points, received from the mapper 304 or, in cases of multiple-input, multiple-output (MIMO) or multi-user multiple-input, multiple-output (MU-MIMO), the spatial mapper, into a time domain block (e.g., a symbol) through an inverse discrete Fourier transform or an inverse fast Fourier transform. When employing the space-time block code encoder and the spatial mapper, a dedicated inverse Fourier transform 306 may be provided for each transmit chain.

When conducting a multiple-input, multiple-output (MIMO) or multi-user multiple-input, multiple-output (MU-MIMO) transmission, the TxSP 324 may incorporate cyclic shift diversities to avert unintended beamforming. The cyclic shift diversities insertion can occur either before or after the inverse Fourier transform 306 process. It can be applied specifically for each transmit chain or for each space-time stream. Alternatively, cyclic shift diversities may be integrated as part of the spatial mapping process.

In multiple-input, multiple-output (MIMO) or multi-user multiple-input, multiple-output (MU-MIMO) transmissions conducted by the TxSP 324, specific blocks preceding the spatial mapper are allocated individually for each user.

The guard interval inserter 308 appends a guard interval to the beginning of each symbol output by the inverse Fourier transform 306. This guard interval typically comprises a cyclic prefix, which is a duplicate of the symbol's concluding segment, placed before the symbol to mitigate interference. Optionally, the TxSP 324 can apply windowing to each symbol post-guard interval insertion to smooth out the symbol edges.

The RF transmitter 342 converts the baseband symbols into a radio frequency (RF) signal and then transmits this RF signal through antenna 352. In cases where the TxSP 324 supports multiple-input, multiple-output (MIMO) or multi-user multiple-input, multiple-output (MU-MIMO) transmissions, both the guard interval inserter 308 and the RF transmitter 342 are configured for each individual transmit chain.

FIG. 3B illustrates components of a wireless local area network (WLAN) device 104 configured to receive data, including a receiver signal processing unit 326 (RxSPU 326), a radio frequency (RF) receiver 344 (RF receiver 344), and an antenna 354. In this embodiment, the RxSPU 326, RF receiver 344, and antenna 354 correspond to the receiving SPU 226, the RF receiver 244, and one of the antennas in the antenna unit 250 of FIG. 2, respectively.

The RxSPU 326 includes a guard interval remover 318, a Fourier transformer 316 (FT 316), a demapper 314, a deinterleaver 312, and a decoder 310.

The RF receiver 344 receives a radio frequency (RF) signal via the antenna 354 and converts the RF signal into symbols. The guard interval remover 318 then removes the guard interval from each symbol. When the received transmission employs multiple-input, multiple-output (MIMO) or multi-user multiple-input, multiple-output (MU-MIMO) technology, the RF receiver 344 and the guard interval remover 318 may be allocated for each receive chain.

The FT 316 converts each symbol (e.g., each time domain block) into a frequency domain block of constellation points using either a discrete Fourier transform (DFT) or a fast Fourier transform (FFT). FT 316 may be allocated for each receive chain.

When the received transmission is a multiple-input, multiple-output (MIMO) or multi-user multiple-input, multiple-output (MU-MIMO) transmission, the RxSP 326 may include a spatial demapper that converts the outputs of the FTs 316 from the receiver chains into constellation points of multiple space-time streams. Additionally, a space-time block code decoder may be employed for despreading the constellation points from the space-time streams into one or more spatial streams.

The demapper 314 demaps the constellation points output from the FT 316 or the space-time block code decoder to bit streams. If the received transmission was encoded using low-density parity-check encoding, demapper 314 may further perform low-density parity-check tone demapping before performing the constellation demapping.

The deinterleaver 312 deinterleaves the bits of each stream output from the demapper 314. It performs deinterleaving specifically when the received transmission was encoded with binary convolutional code encoding. Otherwise, it may pass the stream from demapper 314 without any deinterleaving.

When the received transmission employs multiple-input, multiple-output (MIMO) or multi-user multiple-input, multiple-output (MU-MIMO) technology, the RxSP 326 may incorporate multiple demappers 314 and deinterleavers 312, matching the number of spatial streams in the transmission. In such scenarios, the RxSP 326 may also include a stream deparser for aggregating the outputs from the deinterleavers 312.

The decoder 310 processes the streams emanating from either deinterleaver 312 or the stream deparser. In a specific embodiment, the decoder 310 is equipped with a forward error correction (FEC) decoder. This FEC decoder can be configured as either a binary convolutional code decoder or a low-density parity-check decoder.

The RxSP 326 might also incorporate a descrambler to revert the decoding process on the decoded data. If binary convolutional code decoding is executed by decoder 310, the RxSP 326 could additionally employ an encoder deparser for aggregating the data decoded by multiple binary convolutional code decoders. Conversely, if low-density parity-check decoding is carried out by decoder 310, the use of the encoder deparser may not be necessary.

Before initiating a transmission, wireless devices, including wireless device 104, assess the availability of the wireless medium through clear channel assessment (CCA). CCA determines the medium as busy if it is occupied, and idle if it is available.

The physical (PHY) entity of Institute of Electrical and Electronics Engineers (IEEE) 802.11 is based on Orthogonal Frequency Division Multiplexing (OFDM) or Orthogonal Frequency Division Multiple Access (OFDMA). In both OFDM and OFDMA Physical (PHY) layers, a station, such as wireless device 104, can transmit and receive PHY Protocol Data Units (PPDUs) in accordance with the mandatory PHY specifications. These specifications define a set of Modulation and Coding Schemes (MCS) and the maximum number of spatial streams. Certain PHY entities also specify downlink (DL) and uplink (UL) Multi-User (MU) transmissions, detailing a maximum number of space-time streams (STS) per user and a total number of STSs. PHY entities may support channel widths of 10 MHz, 20 MHz, 40 MHz, 80 MHz, 160 MHz, 240 MHz, and 320 MHz for contiguous channels, as well as 80+80, 80+160 MHz, and 160+160 MHz for non-contiguous channels. Each channel comprises multiple subcarriers, also known as tones. PHY entities define signaling fields within a PPDU, such as Legacy Signal (L-SIG), Signal A (SIG-A), and Signal B (SIG-B), to communicate essential information about PHY Service Data Unit (PSDU) attributes. For clarity and conciseness, the descriptions that follow will focus on OFDM-based 802.11 technology, referring to a station as a non-access point station unless specified otherwise.

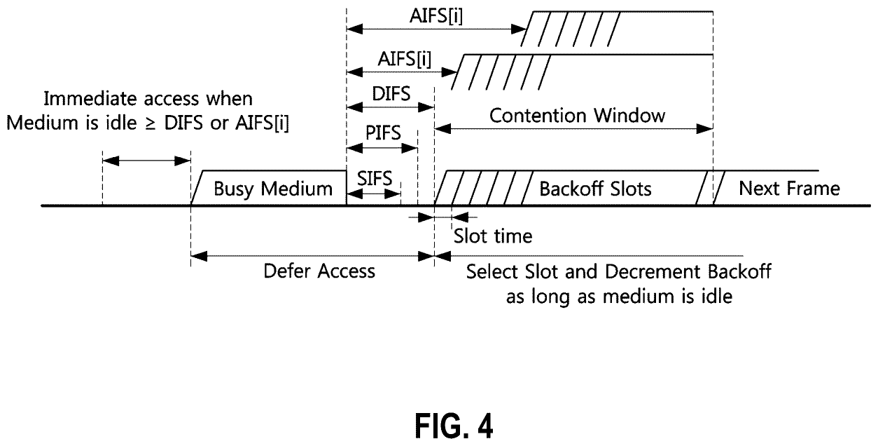

FIG. 4 illustrates the relationships among Inter-Frame Spaces (IFSs), showcasing a Short IFS (SIFS), a Point Coordination Function IFS (PIFS), a Distributed Coordination Function IFS (DIFS), and an Arbitration IFS (AIFS) for Access Category ‘i’ (AIFS [i]). Additionally, the figure depicts a slot time and the transmission of a data frame, which is forwarded to a higher layer for processing. As illustrated, a wireless local area network (WLAN) device 104 initiates the transmission of the data frame following a backoff period, provided that a DIFS duration has passed with the medium remaining idle.

Management frames are utilized to exchange management information, which is not forwarded to higher layers. The subtypes of management frames include beacon frames, association request/response frames, probe request/response frames, and authentication request/response frames.

Control frames are employed to manage access to the medium. The subtypes of control frames encompass Request to Send (RTS), Clear to Send (CTS), and Acknowledgement (ACK) frames.

When the control frame does not serve as a response to another frame, wireless local area network (WLAN) device 104 transmits the control frame after initiating a backoff procedure, provided a DIFS (Distributed Coordination Function Inter-Frame Space) period has passed with the medium being idle. Conversely, if the control frame is a response to another frame, WLAN device 104 transmits the control frame following a SIFS (Short Inter-Frame Space) period, without performing a backoff or assessing the medium's idle status.

A wireless local area network (WLAN) device 104 equipped with quality of service (QoS) capabilities (sometimes referred to as a “QoS STA”) may initiate frame transmission after a backoff period, provided that the Arbitration Inter-Frame Space (AIFS) corresponding to the access category (AC) associated with the frame (i.e., AIFS [AC]) has elapsed. For transmissions by a QoS STA, data frames, management frames, and control frames (excluding response frames) can utilize the AIFS [AC] designated for the AC of the frame being transmitted.

A wireless local area network (WLAN) device 104 may initiate a backoff procedure upon finding the medium occupied when it is prepared to transmit a frame. This procedure entails calculating a random backoff duration encompassing N backoff slots, with each slot corresponding to a predefined slot time and N representing an integer greater than or equal to zero. The selection of the backoff period is influenced by the size of the Contention Window (CW). Furthermore, the backoff duration can be adjusted based on the Access Category (AC) of the frame in question. The commencement of all backoff slots follows either a Distributed Coordination Function Inter-Frame Space (DIFS) or an Extended Inter-Frame Space (EIFS), during which the medium must be observed as idle for the entirety of the interval.

When the wireless local area network (WLAN) device 104 observes no activity on the medium for the length of a designated backoff slot, the backoff procedure mandates reducing the backoff time by one slot time. Should the WLAN device 104 find the medium occupied during a backoff slot, the backoff process is paused and resumes only after the medium is perceived as idle for a complete Distributed Coordination Function Inter-Frame Space (DIFS) or Extended Inter-Frame Space (EIFS) interval. The device is then authorized to initiate the transmission or retransmission of the frame once the backoff timer counts down to zero.

The backoff procedure functions such that when multiple wireless local area network (WLAN) devices 104 defer and initiate the backoff process, each device selects a backoff time through a random function. The device with the shortest backoff time gains priority in the contention, thereby minimizing the likelihood of a collision.

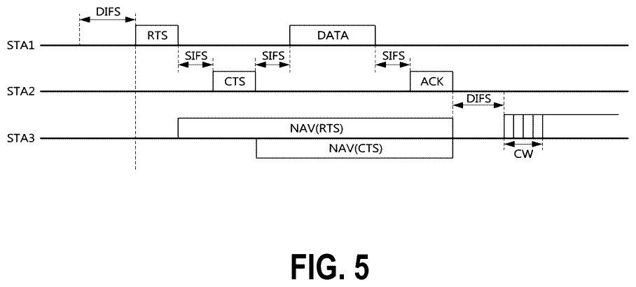

FIG. 5 illustrates a Carrier Sense Multiple Access with Collision Avoidance (CSMA/CA)-based frame transmission procedure designed to prevent collisions among frames on a channel, according to an embodiment. It depicts a first station (STA1) transmitting data, a second station (STA2) receiving the data, and a third station (STA3) situated in an area where it can receive a frame from either STA1, STA2, or both. Stations STA1, STA2, and STA3 may represent WLAN devices 104 as shown in FIG. 1.

The station STA1 may assess whether the channel is occupied by performing carrier sensing. It can determine the channel's status based on the energy level present in the channel, the autocorrelation of signals within the channel, or by utilizing a Network Allocation Vector (NAV) timer to ascertain channel occupation.

After determining that the channel is not occupied by other devices (i.e., the channel is IDLE) during a DIFS (and performing backoff, if required), the station STA1 may transmit a Request-To-Send (RTS) frame to station STA2. Upon receiving the RTS frame, after a SIFS, station STA2 may transmit a Clear-To-Send (CTS) frame in response. If Dual-CTS is enabled and station STA2 is an access point, the access point may issue two CTS frames in response to the RTS frame—for example, a first CTS frame in a non-High Throughput (non-HT) format and a second CTS frame in the High Throughput (HT) format.

When station STA3 receives the RTS frame, it may set its Network Allocation Vector (NAV) timer for the transmission duration of subsequently transmitted frames (for example, a duration of SIFS+CTS frame duration+SIFS+data frame duration+SIFS+ACK frame duration) using the duration information included in the RTS frame. If station STA3 receives the CTS frame, it may set its NAV timer for the transmission duration of subsequently transmitted frames based on the duration information included in the CTS frame. Upon receiving a new frame before the NAV timer expires, station STA3 may update its NAV timer using the duration information from the new frame. Station STA3 does not attempt to access the channel until its NAV timer expires.

When station STA1 receives the CTS frame from station STA2, it may transmit a data frame to station STA2 after a SIFS period elapses from the time when the CTS frame has been completely received. Upon successfully receiving the data frame, station STA2 may transmit an ACK frame in response to the data frame after a SIFS period elapses.

When the NAV timer expires, the third station STA3 may determine whether the channel is busy using carrier sensing. Upon determining that the channel is not occupied by other devices during a DIFS period after the NAV timer has expired, station STA3 may attempt to access the channel after a contention window elapses, according to a backoff process.

When Dual-CTS is enabled, a station that has obtained a transmission opportunity (TXOP) and that has no data to transmit may transmit a CF-End frame to cut short the TXOP. An access point receiving a CF-End frame with the Basic Service Set Identifier (BSSID) of the access point as the destination address may respond by transmitting two additional CF-End frames: the first CF-End frame using Space Time Block Coding (STBC) and the second CF-End frame using non-STBC. A station receiving a CF-End frame resets its NAV timer to 0 at the end of the PHY Protocol Data Unit (PPDU) containing the CF-End frame. FIG. 5 illustrates station STA2 transmitting an ACK frame to acknowledge the successful reception of a frame by the recipient.

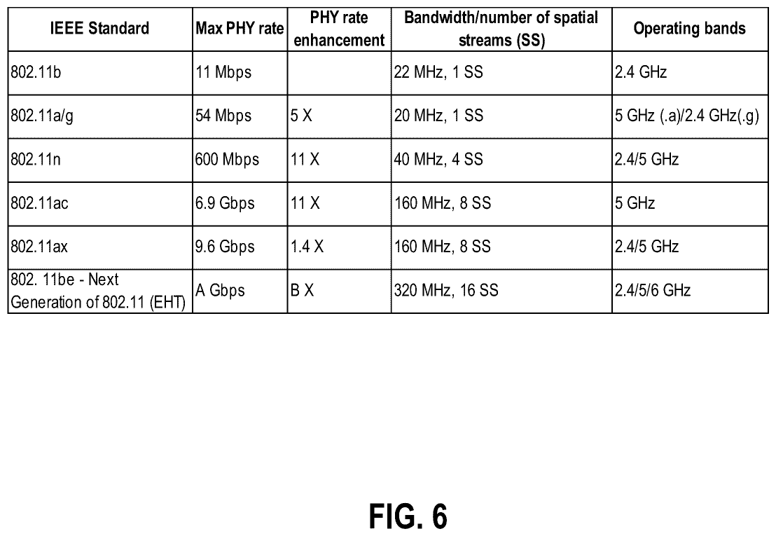

With clear demand for higher peak throughput/capacity in Wi-Fi, a new working group for an amendment called 11be (Extreme High Throughput, EHT) has been created to support an increase in the peak PHY rate. Considering 802.11b to 802.11ac, the peak PHY rate has increased by a factor of 5 or 11, as shown in the table of FIG. 6. In the case of 11ax, known as Wi-Fi 6, the 11ax working group focused on improving efficiency, not peak PHY rate, in dense environments. Note that the Max PHY data rate (in gigabits per second (Gbps)) and PHY rate enhancement (factor) for 11be could rely on the highest MCS (e.g., 4,096 QAM and its code rate) to be determined.

The focus of 11be is on wireless local area network (WLAN) indoor and outdoor operation with stationary and pedestrian speeds in the 2.4, 5, and 6 gigahertz (GHz) frequency bands. In addition to the peak PHY rate, different candidate features are under discussion, include some or all of: 320 MHz bandwidth and more efficient utilization of non-contiguous spectrum; multi-band/multi-channel aggregation and operation; 16 spatial streams and multiple-input, multiple-output (MIMO) protocol enhancements; multi-access point coordination (e.g., coordinated and joint transmission); enhanced link adaptation and retransmission protocol (e.g., Hybrid Automatic Repeat Request (HARQ)); and, if needed, adaptation to regulatory rules specific to the 6 GHz spectrum.

Some features, like increasing the bandwidth and the number of spatial streams, are solutions that have been proven to be effective in previous projects focused on increasing link throughput and for which feasibility demonstration is achievable.

As for operation bands (2.4/5/6 gigahertz (GHz)) for 11be, more than 1 GHz of additional unlicensed spectrum is likely to be available around the year 2020 because the 6 GHZ band (5.925-7.125 GHZ) is being considered for unlicensed use. It would allow access points and stations to become tri-band devices. Larger than 160 MHz data transmission (e.g., 320 MHz) could be considered to increase the max PHY rate. For example, 320 MHz or 160+160 MHz data could be transmitted in the 6 GHz band. Alternatively, 160+160 MHz data could be transmitted across the 5 and 6 GHz bands.

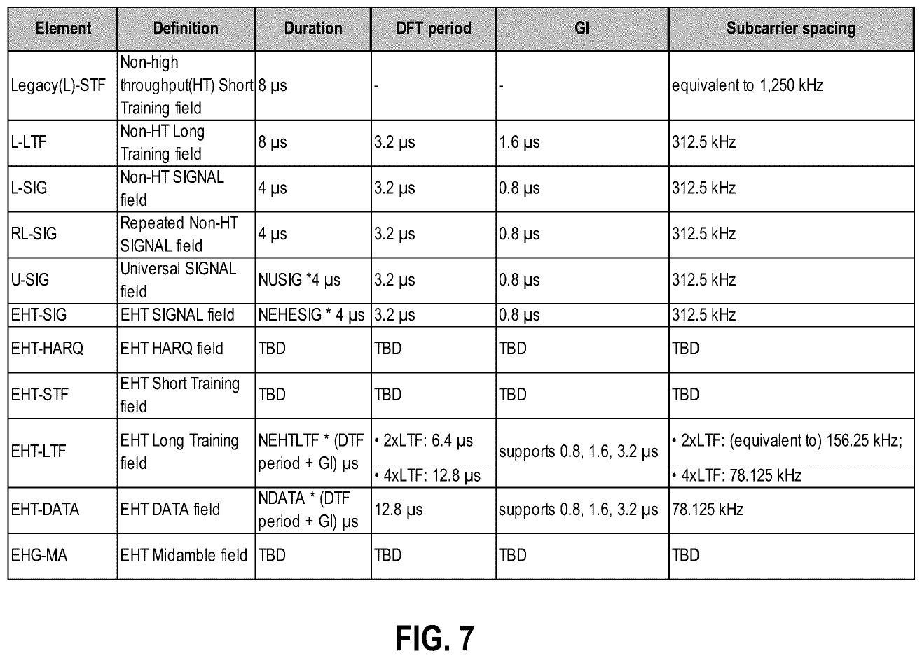

A transmitting station generates a PHY Protocol Data Unit (PPDU) frame and transmits it to a receiving station. The receiving station receives, detects, and processes the PPDU. If an Extremely High Throughput (EHT) PPDU frame comprises a legacy part (e.g., an L-STF field, an L-LTF field, and an L-SIG field), an EHT-SIG-A field, an EHT-SIG-B field, an EHT-HARQ field, an EHT-STF field, an EHT-LTF field, and an EHT-DATA field, then the table of FIG. 7 describes the fields of the EHT PPDU frame in more detail. However, many fields remain empty and are yet to be determined for further discussion.

The distributed nature of channel access networks, such as Institute of Electrical and Electronics Engineers (IEEE) 802.11 wireless local area networks (WLANs), makes the carrier sense mechanism important for collision-free operation. The physical carrier sense of one station is responsible for detecting the transmissions of other stations. However, it may be impossible to detect every single case in some circumstances. For example, one station, which may be a long distance away from another station, may see the medium as idle and begin transmitting frames as well. To overcome this hidden node problem, the network allocation vector (NAV) has been introduced. However, as the IEEE 802.11 standard evolves to include multiple users' simultaneous transmission/reception scheduled within a BSS, such as UL/DL MU transmission in a cascaded manner, modified or newly defined mechanisms may be needed.

In this disclosure, multi-user (MU) transmission refers to cases where multiple frames are transmitted to or from multiple stations simultaneously using different resources, wherein examples of different resources are different frequency resources in OFDMA transmission and different spatial streams in multi-user multiple-input, multiple-output (MU-MIMO) transmission. Therefore, DL-OFDMA, DL-MU-MIMO, UL-OFDMA, and UL-MU-MIMO are examples of MU transmission.

Wireless local area network (WLAN) systems rely on the retransmission of medium access control (MAC) MPDUs when the TX (transmitter) does not receive the acknowledgment from the RX (receiver) OR when MPDUs are not decoded at the RX. In this ARQ (automatic repeat request) approach, the receiver discards the last failed MPDU before receiving the newly retransmitted one. With the requirements for enhanced reliability and reduced latency, the 11be working group decided that it should evolve toward hybrid ARQ (HARQ).

There are two methods of HARQ processing. In the Type 1 HARQ scheme, also referred to as chase combining (CC), the signals to be retransmitted in this part are the same as the signals that failed before because all subpackets to be retransmitted use the same puncturing pattern. Puncturing is needed to remove some of the parity bits after encoding with an error-correction code. The reason for using the same puncturing pattern in CC-HARQ is to generate the coded data sequence with forward error correction (FEC) and make the receiver use maximum-ratio combining (MRC) to combine the received bits with the same bits from previous transmissions. In wireless local area network (WLAN) systems, four subpackets are created from one HARQ packet. For example, the information sequences are usually transmitted in packets with a fixed length. At a receiver, error correction and detection are carried out on the whole packet. If the packet is found to be in error, the conventional ARQ scheme is inefficient in the presence of burst errors. To solve this problem more efficiently, this situation can be improved if subpackets are applied. In subpacket transmissions, only those subpackets that include errors need to be retransmitted.

With subpackets, since the receiver uses both the current and the previously received subpackets to decode, the error probability in decoding decreases as the number of used subpackets increases. The decoding process passes the CRC check and ends when the packet is decoded without errors or the maximum number of subpackets is reached. Basically, because it operates in the stop-and-wait protocol, if the terminal can decode the packet, it sends an ACK to the transmitter. When the transmitter receives the ACK correctly, it terminates the HARQ transmission of the packet. If the terminal cannot decode the packet, it sends a NAK to the transmitter, and the transmitter performs the retransmission process.

In the Type 2 HARQ scheme, also referred to as Incremental Redundancy (IR), different puncturing patterns are used for each subpacket, so the signal of this portion changes for each subpacket. IR uses two puncturing patterns, alternating for odd-numbered and even-numbered transmissions, respectively, resulting in the coded data sequence with the coding rate which is used in IR HARQ. The redundancy scheme of IR improves the LLR (Log Likelihood Ratio) of the parity bits in order to combine information sent across different transmissions due to requests and lowers the code rate as additional subpackets are used, resulting in a lower error rate of the subpackets than CC. The puncturing pattern used in HARQ is indicated by the Subpacket Identity (SPID). The SPID of the first subpacket is always set to 0, and all the systematic bits and the punctured parity bits are transmitted in the first subpacket, and self-decoding is possible when the receiving SNR environment is good. Generally, subpacket SPIDs to be transmitted are in increasing order but can be exchanged except for the first SPID.

As wireless local area network (WLAN) systems have improved, access point coordination has been discussed as a possible technology to be adopted in 11be, where there is a high-level classification depending on various access point coordination schemes. For example, there are two main types of techniques: the first type, called “coordinated,” where data for a user is sent from a single access point, and the second type, called “joint,” where data for a user is sent from multiple access points.

As for coordinated access point tech, multiple access points are either 1) transmitting on the same frequency resource based on coordination and forming spatial nulls to allow for simultaneous transmission from multiple access points, or 2) transmitting on orthogonal frequency resources by coordinating and splitting the spectrum to use it more efficiently. As for joint access point tech, multiple access points are transmitting jointly to a given user.

The solutions provided herein have been described with reference to a wireless LAN system; however, these solutions are also applicable to other network environments, such as cellular telecommunication networks, wired networks, etc.

An embodiment of the invention may be an article of manufacture in which a non-transitory machine-readable medium (such as microelectronic memory) has stored thereon instructions which program one or more data processing components (generically referred to here as a “processor” or “processing unit”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment of the invention may be an apparatus (e.g., an access point station, a non-access point station, or another network or computing device) that includes one or more hardware and software logic structures for performing one or more of the operations described herein. For example, as described above, the apparatus may include a memory unit, which stores instructions that may be executed by a hardware processor installed in the apparatus. The apparatus may also include one or more other hardware or software elements, including a network interface, a display device, etc.

### Efficient Resource Allocation and Utilization in C-TDMA Transmission

Multi-Access Point (M-AP) coordination is a technology that enables multiple access points to collaborate and coordinate their transmissions to improve spectral efficiency, reduce interference, and enhance the overall performance of wireless networks. M-AP coordination technology provides two key advantages. First, it increases spectral efficiency, which means that the available wireless spectrum is utilized more effectively, allowing for higher data throughput. Second, M-AP technology also helps decrease delay, which is useful for time-sensitive applications and enhancing the overall user experience.

Several M-AP technologies are currently under consideration for standard adoption. One technology is Coordinated BF/Nulling (Co-BF/Nulling). CO-BF/Nulling aims to reduce interference between M-APs by sharing Channel State Information (CSI) feedback. This allows the M-APs to coordinate their beamforming and nulling strategies, minimizing the impact of interference on the wireless network. Another M-AP technology is Joint Transmission (JTX). JTX enables multiple M-APs to transmit data simultaneously. This approach can potentially increase the overall data throughput and improve the efficiency of the wireless network. Yet another technology is Coordinated OFDMA/TDMA (C-OFDMA/C-TDMA). C-OFDMA/C-TDMA leverages both time and frequency resources in a cooperative manner to enhance system throughput. By coordinating the allocation of time and frequency resources among M-APs, C-OFDMA/C-TDMA can optimize the utilization of the available wireless spectrum, leading to improved network performance.

The various M-AP technologies have their own strengths and weaknesses. However, C-TDMA technology stands out in terms of fairness. To illustrate, consider an example where data to be transmitted is located at the devices of a non-TXOP (Transmit Opportunity) holder. In this scenario, C-TDMA technology allows the non-TXOP holder to access the channel and transmit its data, ensuring a fair distribution of resources among the participating devices.

There are additional benefits of C-TDMA technology. First, unlike coordinated BF/Nulling (C-BF/Nulling) technology, C-TDMA does not require the feedback of Channel State Information (CSI). This simplifies the implementation and reduces the overhead associated with the feedback process. Second, compared to JTX technology, C-TDMA offers a relatively simpler implementation in terms of mitigating synchronization issues between access points (APs). Synchronization is a useful aspect of M-AP coordination, and C-TDMA's approach to addressing this challenge is more straightforward compared to JTX technology.

Nonetheless, effectively implementing C-TDMA technology in a M-AP scenario depends on sharing control information among the participating APs. To facilitate the sharing of control information, the participating APs can be divided into two categories: a sharing AP and shared AP(s). The sharing AP, also known as the TXOP (Transmit Opportunity) holder, is responsible for initiating and managing the C-TDMA process. On the other hand, the shared AP(s), or non-TXOP holder(s), are the recipients of the shared resources and participate in the C-TDMA scheme as directed by the sharing AP. The sharing AP takes the lead in distributing control information, while the shared AP(s) act upon the received information to ensure the smooth operation of the C-TDMA technology in the M-AP scenario.

The shared control information between the sharing AP and shared AP(s) in a C-TDMA scheme includes useful elements such as the Resource Unit (RU) allocation available during the allocated time and the duration of the allocation itself. However, a potential issue that may arise in dense network scenarios where multiple APs are deployed in close proximity. In such cases, the shared AP(s) may encounter difficulties in utilizing the RU allocated by the sharing AP. The reason behind this is that the RU, which appears to be available from the sharing AP's perspective, may be subject to interference caused by unpredictable signals from overlapping basic service set (OBSS) APs or other sources. If the shared AP is unable to fully utilize the allocated RU within the designated time frame due to this interference, it leads to a wastage of valuable network resources. Moreover, this underutilization of the allocated RU can have a detrimental effect on the overall system throughput, as the available resources are not being used efficiently.

Thus, there is a need for a solution that can effectively address the challenges posed by interference in dense network environments. By identifying and mitigating the impact of interference on the shared AP's ability to utilize the allocated RU, the efficiency of the C-TDMA scheme can be improved, leading to better resource utilization and enhanced system throughput.

A solution disclosed herein addresses the issue of interference affecting the availability of Resource Units (RUs) during the allocated duration time in the context of C-TDMA schemes by extending the concept of the Multi-User (MU) Request-to-Send (TXS) Transmit Opportunity Sharing (TXS) frame used in the IEEE 802.11be standard. The MU-RTS TXS frame is a trigger frame that facilitates the coordination of multiple users in a wireless network. By leveraging and building upon the functionality of this frame, a mechanism is developed that can effectively manage RUs that become unavailable due to interference during the allocated time slot.

It should be noted that the disclosed solution is not limited to the current IEEE 802.11be standard but is also intended to be applicable to future standards, such as the Ultra High Rate (UHR) standard. By proactively addressing the interference issue and its impact on RU availability, the efficiency and reliability of C-TDMA schemes in both existing and upcoming wireless communication standards is improved.

### User Information Subfield of Enhanced MU-RTS TXS Trigger Frame

In an embodiment, the enhanced MU-RTS TXS trigger frame is utilized by the AP that holds the TXOP (Transmit Opportunity), referred to as the sharing AP. The purpose of the enhanced MU-RTS TXS frame is to enable the sharing AP to share its TXOP with other APs, known as shared APs. By doing so, the sharing AP facilitates the collaboration and coordination of transmissions among the participating APs in the C-TDMA scheme.

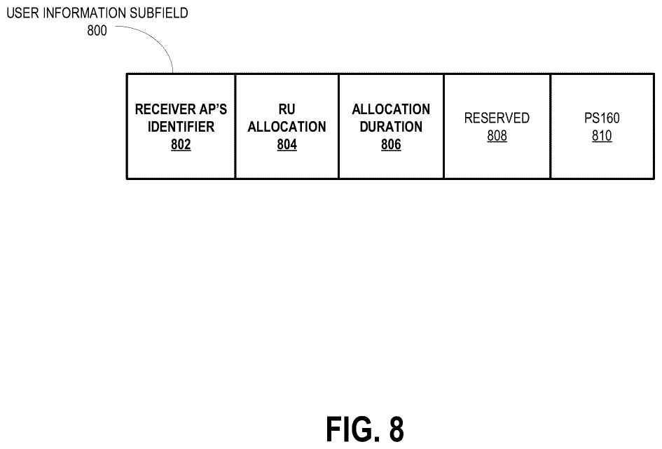

FIG. 8 provides a visual representation of the format of the user information subfield 800 within an enhanced MU-RTS TXS trigger frame, according to an embodiment. An instance of the user information subfield within the enhanced MU-RTS TXS frame contains the receiver AP's identifier 802, a Resource Unit (RU) allocation 804, an allocation duration field 806, a reserved field 808, and a PS160 field 810.

In the context of C-TDMA, when the sharing AP (the AP that holds the TXOP) transmits an enhanced MU-RTS TXS trigger frame to a shared AP, the shared AP assumes the role of the receiver AP. The receiver AP's identifier field 802 is used to identify and address the specific shared AP that is the intended recipient of the enhanced MU-RTS TXS frame. By including the receiver AP's identifier in the user information subfield 800, the sharing AP can clearly communicate and direct the information contained within the enhanced MU-RTS TXS frame to the appropriate shared AP. This identification mechanism ensures that the shared AP can properly interpret and act upon the received information, such as the allocated resources and duration, enabling effective coordination and collaboration among the APs participating in the C-TDMA scheme.

In the case where the shared AP is the one transmitting an enhanced MU-RTS TXS trigger frame to the sharing AP, the sharing AP becomes the receiver AP in this specific context. When the shared AP sends an enhanced MU-RTS TXS trigger frame to the sharing AP, the receiver AP's identifier field 802 within the user information subfield 800 is used to identify and address the sharing AP. This means that the receiver AP's identifier represents the sharing AP, indicating that the information contained within the enhanced MU-RTS TXS trigger frame is intended for the sharing AP.

In the case where a shared AP transmits an enhanced MU-RTS TXS trigger frame to another AP, which is also a shared AP in the C-TDMA scheme, the AP receiving the enhanced MU-RTS TXS trigger frame is referred to as the receiver AP. The receiver AP's identifier field 802 within the user information subfield 800 of the enhanced MU-RTS TXS trigger frame is used to identify and address the specific shared AP that is the intended recipient of the frame. By including the receiver AP's identifier, the transmitting shared AP can clearly indicate which other shared AP should process and act upon the information contained within the enhanced MU-RTS TXS trigger frame.

In an embodiment, the receiver AP's identifier field 802 within the user information subfield 800 of the enhanced MU-RTS TXS trigger frame has three possible formats that the identifier could take: the receiver side AP's BSS (Basic Service Set) color, AP-ID (Access Point Identifier), or AP-AID (Access Point Association Identifier). The BSS color is a unique identifier assigned to each BSS, which helps to differentiate between different APs and their associated stations. The AP-ID is a unique identifier assigned to each AP within a network, while the AP-AID is an identifier used to represent the association between an AP and a station. By allowing the receiver AP's identifier to be expressed in one of these three formats, the C-TDMA mechanism provides flexibility in how APs are identified and addressed within the network. This flexibility enables the enhanced MU-RTS TXS trigger frame to be used in various network configurations and scenarios, accommodating different identification schemes used by APs.

In an embodiment, the RU Allocation field 804 within the user information subfield 800 of the enhanced MU-RTS TXS trigger frame is used to indicate the availability of Resource Units (RUs) at the receiver AP's side, depending on the specific scenario and the roles of the APs involved.

In the first scenario, when the sharing AP transmits an enhanced MU-RTS TXS trigger frame to the shared AP, the RU Allocation field 804 represents the available RUs at the shared AP's side. This information helps the shared AP to understand which RUs it can utilize for its transmissions.

In the second scenario, when the shared AP transmits an enhanced MU-RTS TXS trigger frame to the sharing AP to return its allocated channel resources, the RU Allocation field 804 indicates the available RUs at the sharing AP's side. This communication allows the sharing AP to reclaim and reassign the returned RUs as needed.

The third scenario involves a shared AP transmitting an enhanced MU-RTS TXS trigger frame to another shared AP. In this case, the RU Allocation field 804 represents the available RUs at the other shared AP's side, enabling direct coordination and resource sharing between shared APs.

Some additional fields within the user information subfield 800 of the enhanced MU-RTS TXS frame are the allocation duration field 106, the reserved field 808, and the PS160 field. In the first scenario where the sharing AP transmits the enhanced MU-RTS TXS trigger frame to the shared AP, the allocation duration field 806 represents the portion of the shared TXOP (Transmit Opportunity) that is allocated between the sharing AP and the shared AP. This field 806 indicates the time duration for which the shared AP is allowed to utilize the allocated resources, ensuring efficient coordination, and preventing conflicts in the C-TDMA scheme. The calculation of the allocation duration value for the allocation duration field 806 in the second and third scenarios where the shared AP transmits the enhanced MU-RTS TXS trigger frame to the sharing AP or another shared AP, respectively, is described in greater detail below with respect to discussion of a first solution and a second solution.

The Reserved and PS160 fields 808 and 810 are reused for the same purpose as in the existing MU-RTS TXS trigger frame. The reserved field 808 is typically used for future extensions or additional information that may be required in specific scenarios. The PS160 field 810, on the other hand, is related to the power-saving mechanism in the IEEE 802.11 standard, indicating whether the AP supports the PS160 capability.

### Example Resource Unit (RU) Allocation

The sharing AP transmitting an enhanced MU-RTS TXS frame to the shared AP enables the shared AP to perform C-TDMA. However, a potential issue can arise from the perspective of the shared AP due to interference from unpredictable signals originating from overlapping basic service sets. This interference can prevent the shared AP from fully utilizing the available Resource Units (RUs) allocated by the sharing AP.

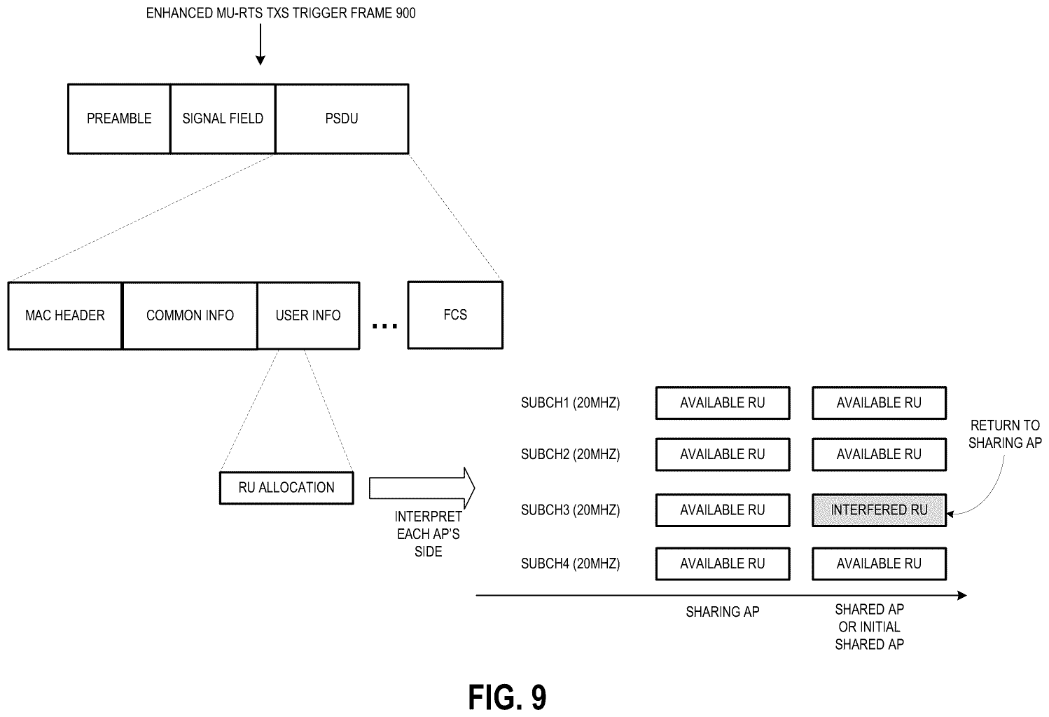

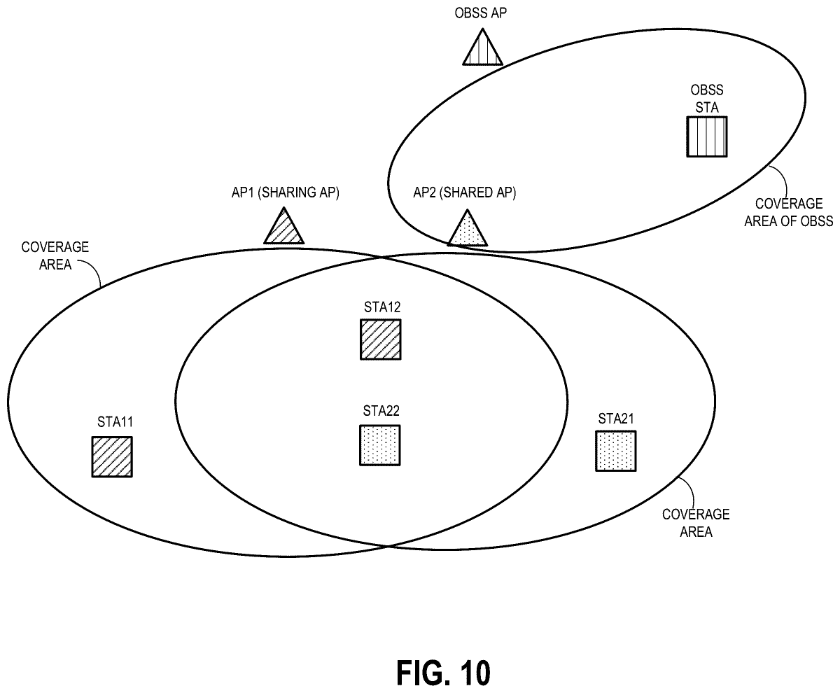

FIG. 9 provides an example of the RU allocation within the user info subfield of the enhanced MU-RTS TXS trigger frame 900, based on the wireless network topology shown in FIG. 10. The interpretation of RU allocations differs depending on the AP's side. While the sharing AP allocates RUs to the shared AP, the shared AP might encounter interference signals that hinder its ability to fully utilize the allocated RUs.

At the shared AP side, the received RU allocation can be divided into two categories: interfered RU and available RU. The interfered RU represents the portion of the allocated RUs that cannot be used by the shared AP due to interference, resulting in wasted resources. Consequently, this underutilization of RUs can lead to a degradation in system throughput.

### First Solution

A first solution is disclosed herein that addresses the issue of the shared AP not being able to fully utilize the allocated resource units (RUs) received from the sharing AP. This issue arises due to interference, which can lead to a waste of resources and a decrease in system throughput. To mitigate this problem, the first solution involves using the user information field of the enhanced MU-RTS TXS trigger frame, as depicted in FIG. 8.

According to the first solution, when the shared AP identifies RUs that are affected by interference and cannot be effectively used, it can return those interfered RUs to the sharing AP. By leveraging the user information field of the enhanced MU-RTS TXS trigger frame, the shared AP can communicate information about the interfered RUs back to the sharing AP.

Once the sharing AP receives the information about the interfered RUs, it can then reallocate those RUs for its own use or assign them to other shared APs that may be able to utilize them more effectively. This approach helps to optimize the utilization of the available RUs and improves overall system throughput by minimizing the waste of resources due to interference.

Referring to FIG. 8, the subfields of the user information field 800 in the enhanced MU-RTS TXS trigger frame, which are used to return the interfered RU from the shared AP to the sharing AP. The first subfield 802 is the Receiver AP's identifier, which represents the sharing AP's identifier that will receive the enhanced MU-RTS TXS trigger frame containing information about the returned interfered RU.

The second subfield 804 is the RU Allocation, which indicates the specific RU that the shared AP has identified as being interfered with and is returning to the sharing AP.

The third subfield 806 is the allocation duration, which is calculated using a specific method when the shared AP cannot fully utilize the RU allocation received from the sharing AP. In an embodiment, the calculation involves three values stored in memory buffers at the shared AP: the allocation duration of the received enhanced MU-RTS TXS frame received from the sharing AP, the duration of the CTS frame sent by the shared AP plus aSIFStime, and the expected duration of the enhanced MU-RTS TXS frame to be transmitted by the shared AP to return the interfered RU plus aSIFStime. The allocation duration is then calculated by subtracting the second and third values from the first value.

aSIFStime, which stands for “Short Interframe Space (SIFS) time,” is a parameter in the IEEE 802.11 wireless local area network (WLAN) standard. It represents the shortest time interval between the transmission of two consecutive frames in a WLAN.

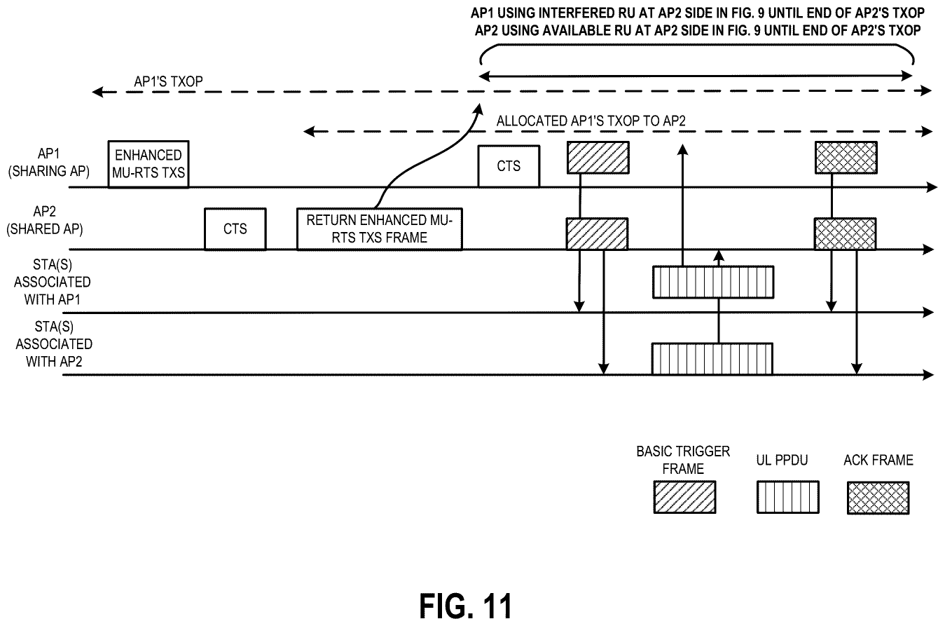

In the context of the frame exchange sequence depicted in FIG. 11, aSIFStime aids in coordinating the communication between the sharing AP and the shared AP. After receiving an enhanced MU-RTS TXS frame from the sharing AP, the shared AP waits for a duration of aSIFStime before sending a CTS (Clear to Send) frame in response. This short time interval ensures that the shared AP has priority access to the medium and can promptly acknowledge the receipt of the enhanced MU-RTS TXS frame.

Similarly, after transmitting the CTS frame, the shared AP waits for another aSIFStime before sending its own enhanced MU-RTS TXS frame to return the interfered RU to the sharing AP. The use of aSIFStime in this case guarantees that the shared AP can quickly transmit its frame without competing with other devices for medium access.

The value of aSIFStime is defined in the IEEE 802.11 standard and is typically much shorter than other interframe space durations, such as DIFS (DCF Interframe Space) or PIFS (PCF Interframe Space). This short duration enables immediate frame exchange between devices, minimizing delays and ensuring efficient communication in the WLAN.

By incorporating aSIFStime in the frame exchange sequence, the first solution ensures that the communication between the sharing AP and the shared AP is well-coordinated and follows the timing requirements specified in the IEEE 802.11 standard. This precise timing helps in maintaining the integrity and reliability of the communication process while efficiently managing the allocation and return of interfered RUs between the APs.

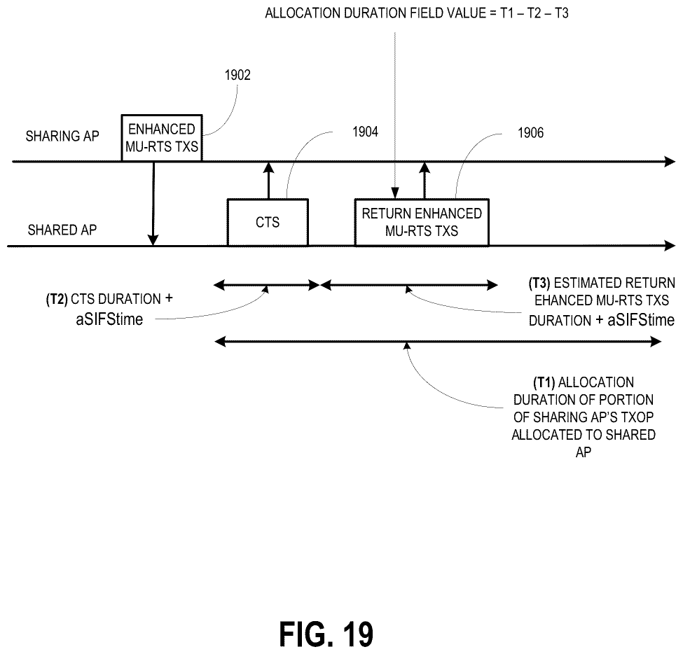

An example of determining the allocation duration at the shared AP to include in the enhanced MU-RTS TXS trigger frame sent to the sharing AP to return the interfered RU to the sharing AP is illustrated in FIG. 19. The shared AP can set the allocation duration field to allow the sharing AP to use the returned RU after decoding enhanced MU-RTS TXS frame from the shared AP. As illustrated, the sharing AP transmits an enhanced MU-RTS TXS trigger frame 902 to the shared AP. Trigger frame 902 allocates a portion of the sharing AP's TXOP to the shared AP. The trigger frame 902 includes the allocation duration of the portion allocated which is designated in FIG. 19 as T1. In response to receiving trigger frame 902, the shared AP transmits a Clear-to-Send (CTS) frame 1904 back to the sharing AP. In doing so, the shared AP measures the duration of transmitting the CTS frame 1904. That measured duration plus the aSIFStime is indicated in FIG. 19 as T2. After the shared AP determines to return an interfered RU to the sharing AP, the shared AP generates an enhanced MU-RTS TXS trigger frame 1906. This trigger frame 1906 includes an allocation duration determined by the shared AP that represents the duration of the remaining portion of the original portion of the TXOP allocated to the shared AP by the sharing AP that the shared AP is returning to the sharing AP for the interfered RU. In an embodiment, this allocation duration is determined by the shared AP by subtracting T2 and T3 from T1 as depicted in FIG. 19. Here, T3 is determined as an estimated duration for transmitting trigger frame 1906 plus the aSIFStime.

The fourth subfields, reserved 808 and PS160 810, are reused for the same purpose as in the existing MU-RTS TXS frame.

FIG. 11 illustrates an example of the frame exchange sequence for the first solution, based on the example wireless network topology shown in FIG. 10 and the example RU allocation situation depicted in FIG. 9. It should be noted that while examples herein depict returning a single interfered RU, the shard AP can return multiple interfered RUs to the sharing AP in cases where multiple interfered RUs are unavailable to the shared AP.

### Second Solution

In the context of the first solution above, there is a potential limitation. A second solution is disclosed herein to address the limitation. The first solution allows the shared AP to return the unavailable RU (e.g., interfered RU) to the sharing AP when the shared AP cannot use the allocated RU due to interference from overlapping basic service set (OBSS) signals. However, the returned unavailable RU might not be useful for the sharing AP either, as the available RU status can change over time.

The reason behind this issue is that the available RU information provided by the sharing AP in the enhanced MU-RTS TXS frame is only valid at the time of transmission. By the time the shared AP returns the unavailable RU to the sharing AP, the channel conditions and available RUs at the sharing AP side might have changed due to the elapsed time.

To address this limitation, a second solution considers both situations: (1) when the shared AP identifies an unavailable RU and (2) when the sharing AP receives the returned unavailable RU. This second solution aims to reflect the channel variation experienced by the shared AP and acknowledges that the interfered RU returned by the shared AP might also be unavailable for use at the sharing AP side.

By considering the dynamic nature of channel conditions and the potential changes in RU availability over time, the second solution enhances the effectiveness of the resource allocation and coordination between the sharing AP and the shared AP. This second solution recognizes that the returned unavailable RU might not always be useful for the sharing AP and takes into account the channel variations experienced by the shared AP.

The second solution builds upon the first solution by introducing the concept of forwarding the unavailable RU (e.g., interfered RU) from the initial shared AP to another shared AP. This approach aims to optimize the utilization of the interfered RU by allowing another shared AP to use it when the initial shared AP and the sharing AP cannot fully utilize the allocated RU.

Referring to FIG. 8, the second solution leverages the user information subfield 800 of the enhanced MU-RTS TXS trigger frame to facilitate the forwarding of the interfered RU to another shared AP. The subfields of the user information subfield 800 are defined to include the information for this process.

The Receiver AP's identifier subfield 802 indicates the identifier of the other shared AP that will receive the enhanced MU-RTS TXS trigger frame containing the information about the forwarded interfered RU. The RU Allocation subfield 802 represents the specific interfered RU that the initial shared AP is forwarding.

The Allocation duration subfield 804 is calculated using a method that considers two cases: (1) when the initial shared AP cannot fully use the RU allocation from the sharing AP, and (2) when the sharing AP cannot use the interfered RU from the initial shared AP. The calculation involves storing three values in memory buffers at the shared AP: (first value) the allocation duration of the received enhanced MU-RTS TXS frame (e.g., T1 in FIG. 19), (second value) the duration of the CTS frame sent by the initial shared AP plus aSIFStime (e.g., T2 in FIG. 19), and (third value) an estimated duration of the enhanced MU-RTS TXS frame transmitted by the initial shared AP to forward the interfered RU to the other shared AP plus aSIFStime. The Allocation duration value for the allocation duration subfield 804 is then calculated by subtracting the second and third values from the first value.

The Reserved and PS160 subfields 808 and 810 are reused for the same purpose as in the existing MU-RTS TXS frame.

By implementing the second solution, the system aims to enhance the efficiency of resource utilization by allowing another shared AP to use the interfered RU when it cannot be fully utilized by the initial shared AP and the sharing AP. This approach considers the dynamic nature of channel conditions and adapts to the changing availability of RUs, potentially improving overall system performance.

Interference from Overlapping Basic Service Sets

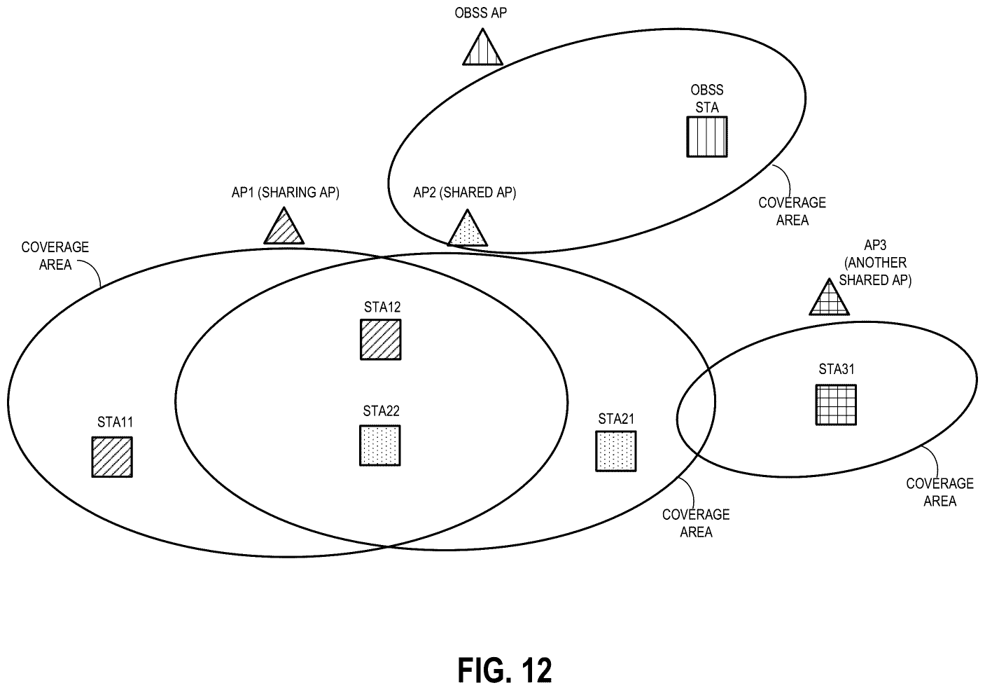

The interpretation of RU allocation can vary depending on the perspective of different APs in the network topology. For example, referring to the example topology shown in FIG. 12, AP1 acts as the sharing AP, while AP2 is the initial shared AP. The RU allocation at AP1 and AP2 sides could be interpreted differently due to the presence of an OBSS (Overlapping Basic Service Set) AP.

At the AP2 side, the RU allocation received from AP2 itself could be perceived as either interfered or available RU. This variation in interpretation is caused by the signal from the OBSS AP, as depicted in FIG. 9. The interference from the OBSS AP can impact the availability and usability of the RUs at the AP2 side.

Consequently, it can be important to consider the impact of OBSS APs on the RU allocation and interpretation process. The presence of overlapping signals from neighboring APs can lead to different perceptions of RU availability and interference at each AP's side.

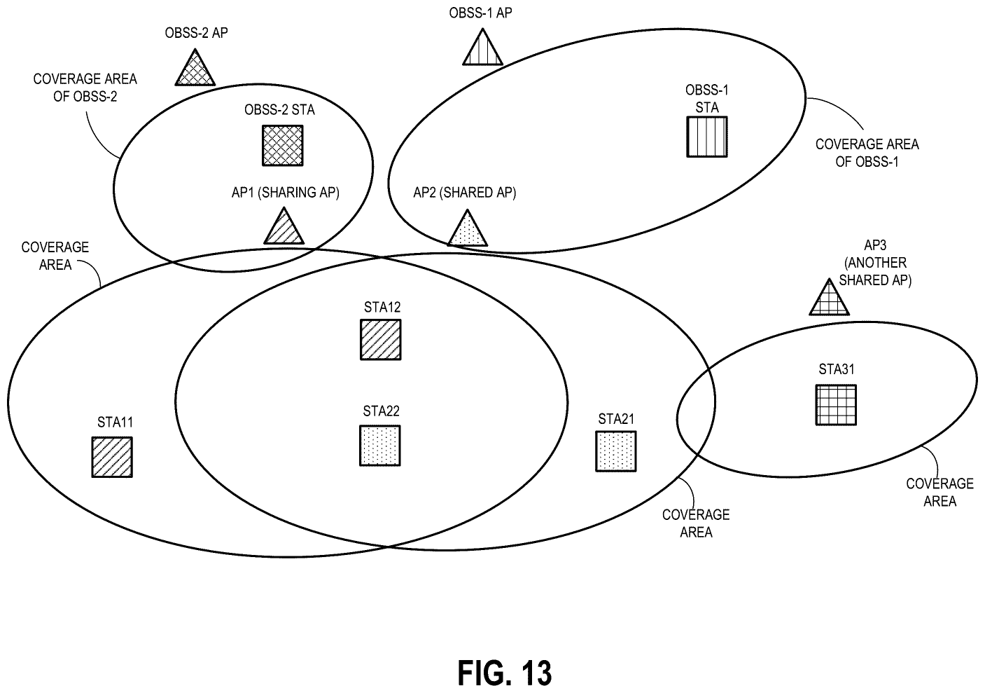

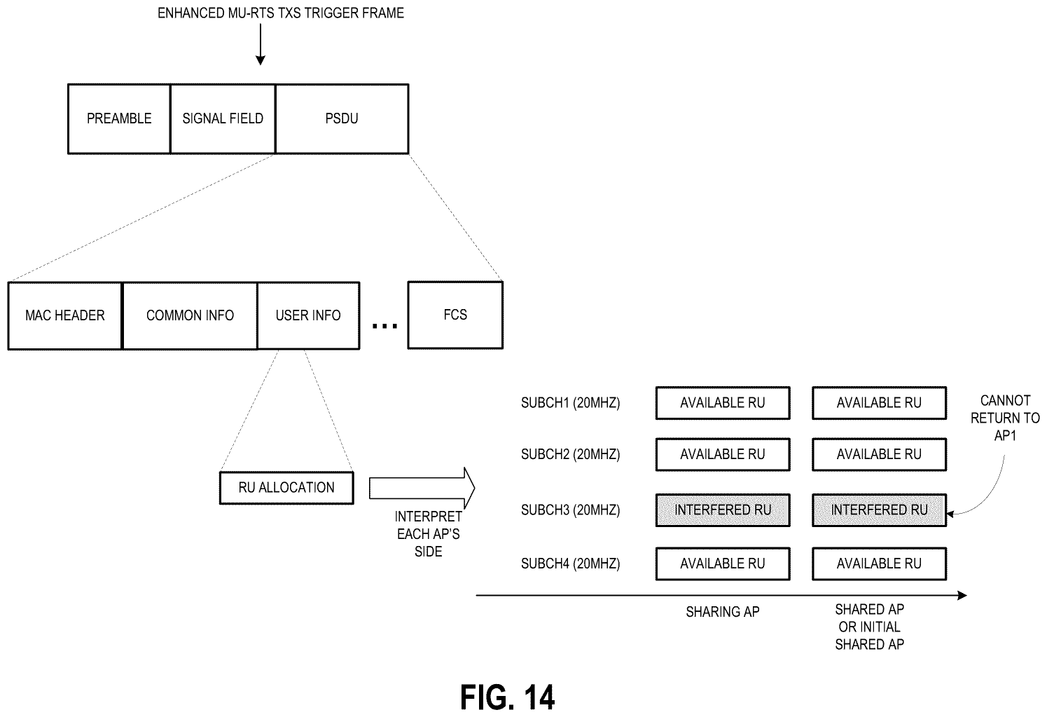

Referring now to FIG. 14, which illustrates the RU allocation of AP1 and AP2 after AP2 successfully decodes the enhanced MU-RTS TXS frame received from AP1. The available RU allocation at the AP1 side in FIG. 14 differs from the allocation shown in FIG. 9. This change in RU availability is attributed to the presence of an OBSS (Overlapping Basic Service Set) signal, represented as OBSS-2 in the FIG. 13 topology.

As a consequence of this OBSS signal interference, AP2 is unable to return its interfered RU to AP1 because AP1 itself cannot utilize this RU due to the OBSS signal interference. This situation underscores the impact of overlapping signals from neighboring APs on the resource allocation and coordination process between AP1 and AP2.

The presence of the OBSS signal not only affects the RU allocation at AP2 but also influences the availability of RUs at AP1. As a result, even if AP2 attempts to return its interfered RU to AP1 (as described in the first solution above), AP1 would not be able to use that RU effectively due to the interference caused by the OBSS signal.

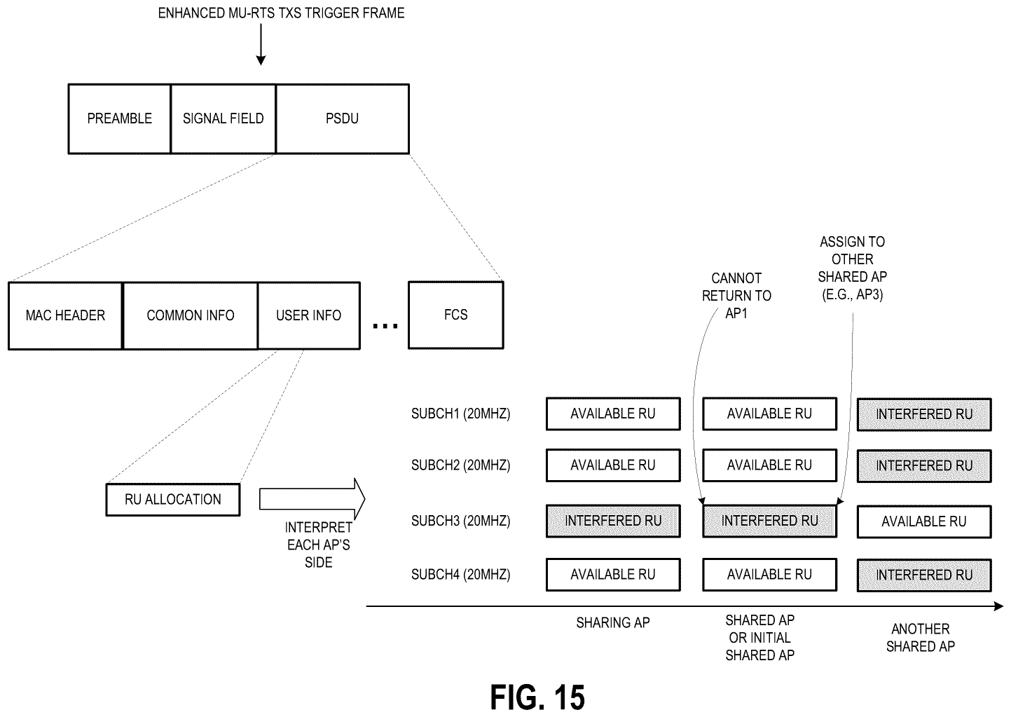

Turning now to FIG. 15, it illustrates the RU allocation at AP1, AP2, and AP3 after AP2 successfully decodes the enhanced MU-RTS TXS trigger frame received from AP1. As shown in FIG. 15, the interfered RU at the AP2 side, which was previously unavailable due to interference, can be assigned and reused at the AP3 side as an available RU. This observation aligns with the concept introduced in the second solution, where the initial shared AP (AP2) forwards its interfered RU to another shared AP (AP3) to optimize resource utilization.

By reassigning the interfered RU from AP2 to AP3, the system can make efficient use of the available resources and potentially improve overall network performance. The RU, which was considered interfered and unusable at AP2, can be effectively utilized by AP3 as an available RU.

By leveraging the enhanced MU-RTS TXS trigger frame and the user information field, the APs can exchange information about the interfered RUs and make intelligent decisions to optimize resource utilization.

The second solution can be implemented to minimize the waste of resources caused by interfered RUs in the context of overlapping basic service sets. By applying the second solution, the system aims to optimize resource utilization and reduce the waste of resources. For example, instead of leaving the interfered RU unused at AP2, it can be reassigned to AP3, where it can be effectively utilized as an available RU. This reallocation process is facilitated by the enhanced MU-RTS TXS frame and the user information field, which enable the exchange of information about the interfered RUs among the APs.

### Example Frame Exchange Sequence

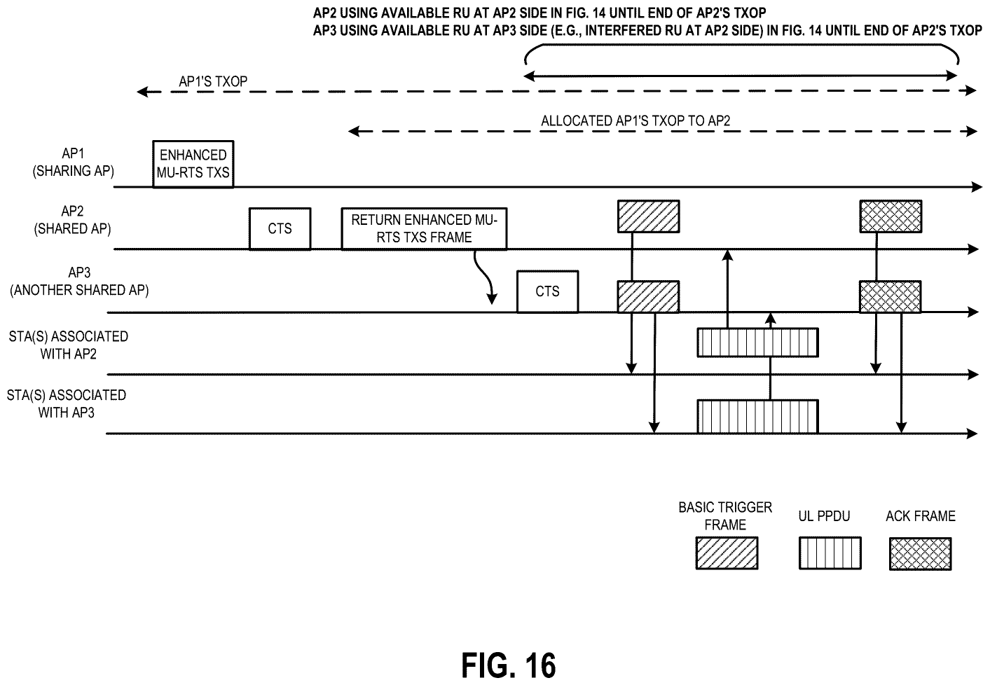

An example of a frame exchange sequence for the second solution is illustrated in FIG. 16. This figure takes into account the topology shown in FIG. 12 and the RU allocation situations depicted in Figures FIG. 9, FIG. 14, and FIG. 15. By considering these different scenarios and the corresponding RU allocations, FIG. 16 provides a comprehensive view of how the second solution can be implemented to optimize resource utilization.

### Implementation Considerations

There are some considerations when implementing the first solution or the second solution in the context of multi-AP (M-AP) coordination and C-TDMA (Coordinated Time Division Multiple Access) operation.

Firstly, when configuring the M-APs to perform C-TDMA, it is useful to determine the roles of the APs involved. The sharing AP and the shared AP(s) can be identified and designated. This is useful for establishing the hierarchical relationship and the coordination mechanism among the APs.

Secondly, each AP's identifier can be shared among the participating APs. For example, the BSS (Basic Service Set) color, which is a unique identifier associated with each AP, can be shared. By exchanging these identifiers through a beacon/probe response frame, the APs can recognize and communicate with each other effectively.

The beacon/probe response frame is a management frame used in wireless networks to advertise the presence of an AP and provide useful information about the network. By including the AP identifiers in these frames, the APs can discover and establish communication with one another, facilitating the coordination process for the first solution or the second solution.

### Example Methods

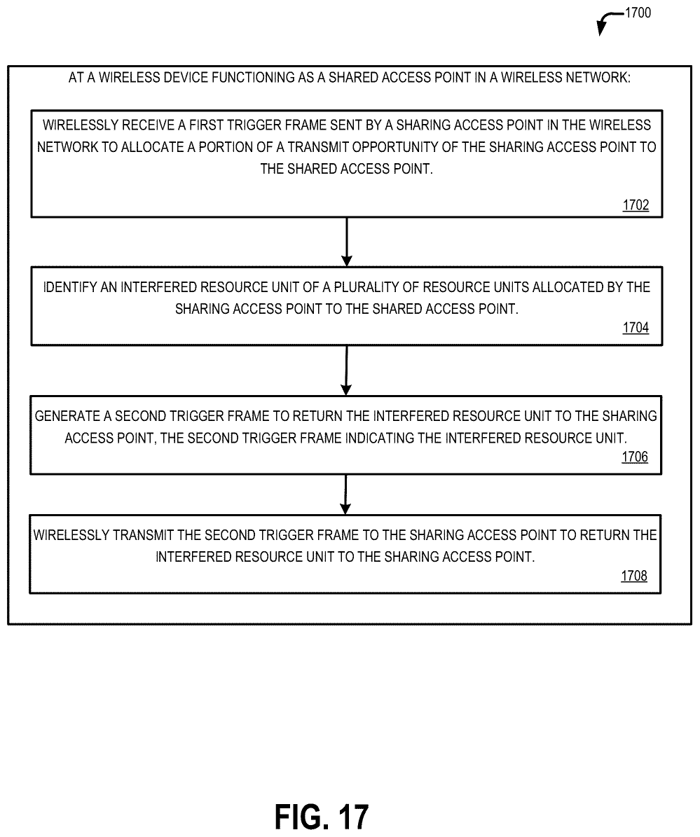

FIG. 17 illustrates a method 1700 performed at a wireless device operating as a shared access point in a wireless network, in accordance with some embodiments of the present disclosure.

At step 1702, the shared access point wirelessly receives a first trigger frame sent by a sharing access point. The shared access point uses its wireless communication interface, such as a Wi-Fi radio, to receive the first trigger frame sent by the sharing access point. The first trigger frame is detected and decoded by the shared access point's physical layer (PHY) and medium access control (MAC) layer. The received first trigger frame contains information about the allocation of a portion of the sharing access point's transmit opportunity to the shared access point.

At step 1704, the shared access point identifies an interfered resource unit. The shared access point analyzes the plurality of resource units allocated to it by the sharing access point, as indicated in the first trigger frame. In an embodiment, the shared access point uses channel sensing mechanisms, such as clear channel assessment (CCA), Virtual Carrier Sensing (VCS), or energy detection, to determine the presence of interference on each allocated resource unit. The shared access point identifies a specific resource unit that is affected by interference, rendering it unsuitable for effective communication.

At step 1706, the shared access point generates a second trigger frame. The shared access point creates a second trigger frame to return the interfered resource unit to the sharing access point. It populates the necessary fields in the second trigger frame, including information about the interfered resource unit, such as its identifier or index. The second trigger frame is formatted according to the specific protocol or standard being used, such as the enhanced MU-RTS TXS frame format disclosed herein.

At step 1708, the shared access point wirelessly transmits the second trigger frame. The shared access point uses its wireless communication interface to transmit the second trigger frame to the sharing access point. The PHY and MAC layers of the shared access point process and encode the second trigger frame for transmission over the wireless medium. The shared access point ensures that the transmission of the second trigger frame adheres to the timing and synchronization requirements of the wireless network, such as following the C-TDMA scheme and considering factors like inter-frame spacing (e.g., aSIFStime).

By following these steps, the shared access point effectively communicates the presence of an interfered resource unit to the sharing access point and returns it for potential reallocation or utilization by other devices in the network. The implementation of each step involves utilizing the wireless communication capabilities of the shared access point, adhering to the specific protocol or standard being used, and ensuring proper timing and synchronization within the wireless network.

In an embodiment of the method 1700, the enhanced MU-RTS TXS frame transmitted by the sharing AP can be formatted using the non-High Throughput (HT) PPDU (Physical Protocol Data Unit) format. This format allows the frame to be duplicated over the total available bandwidth (BW) of the wireless network. For example, if the total bandwidth is 80 MHz, the enhanced MU-RTS TXS frame can be duplicated over each 20 MHz unit within the 80 MHz bandwidth.

The duplication of the enhanced MU-RTS TXS frame over the total bandwidth has several implications in the context of the method 1700. By duplicating the enhanced MU-RTS TXS frame over each 20 MHz unit within the total bandwidth, the sharing AP can use any of these units for communication. This flexibility allows the sharing AP to allocate resource units to the shared access point from any part of the available bandwidth. After receiving the enhanced MU-RTS TXS frame, the maximum available bandwidth at the shared AP side can be up to the total bandwidth, which is 80 MHz in the given example. This means that the shared AP has the potential to utilize the full bandwidth for its communication needs. If there are interfered RUs at the shared AP side, as identified 1704 in the method 1700, the shared AP can return these interfered resource units to the sharing AP using the second trigger frame. The sharing AP can then utilize these returned resource units without any specific conditions or limitations, as they are within the total available bandwidth.

The duplication of the enhanced MU-RTS TXS frame over the total bandwidth ensures that both the sharing AP and the shared AP have a common understanding of the available resources and can effectively coordinate their communication. It allows for efficient allocation, utilization, and return of resource units between the access points.

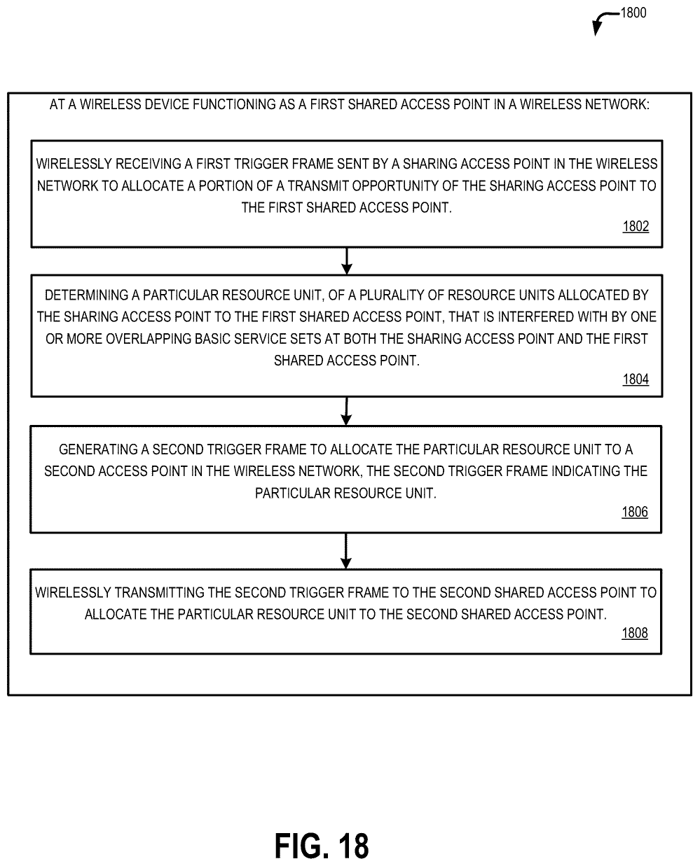

FIG. 18 illustrates a method 1800 performed at a wireless device operating as a first shared access point in a wireless network.

At step 1802, the first shared access point wirelessly receives a first trigger frame sent by a sharing access point in the wireless network. The first shared access point uses its wireless communication interface, such as a Wi-Fi radio, to receive the first trigger frame sent by the sharing access point. The first trigger frame is detected and decoded by the first shared access point's physical layer (PHY) and medium access control (MAC) layer. The received first trigger frame contains information about the allocation of a portion of the sharing access point's transmit opportunity to the first shared access point.

At step 1804, the first shared access point determines a particular resource unit interfered with by one or more overlapping basic service sets. The first shared access point analyzes the plurality of resource units allocated to it by the sharing access point, as indicated in the first trigger frame. It uses channel sensing mechanisms (e.g., Clear Channel Assessment (CCA), Virtual Carrier Sensing (VCS), or energy detection) and coordination with the sharing access point to determine the presence of interference from one or more overlapping basic service sets (OBSS) on each allocated resource unit. The first shared access point identifies a particular resource unit that is interfered with by one or more overlapping basic service sets at both the sharing access point and the first shared access point, making it unsuitable for effective communication by these two access points.

At step 1806, the first shared access point generates a second trigger frame. The first shared access point creates a second trigger frame to allocate the particular interfered resource unit to a second shared access point in the wireless network. It populates the necessary fields in the second trigger frame, including information about the particular resource unit, such as its identifier or index. The second trigger frame is formatted according to the specific protocol or standard being used, such as the enhanced MU-RTS TXS frame format disclosed herein.

At step 1808, the first shared access point wirelessly transmits the second trigger frame. The first shared access point uses its wireless communication interface to transmit the second trigger frame to the second shared access point. The PHY and MAC layers of the first shared access point process and encode the second trigger frame for transmission over the wireless medium. The first shared access point ensures that the transmission of the second trigger frame adheres to the timing and synchronization requirements of the wireless network, such as following the C-TDMA scheme and considering factors like inter-frame spacing (e.g., aSIFStime).

By following these steps, the first shared access point effectively determines a particular resource unit that is interfered with by OBSS at both the sharing access point and the first shared access point. Instead of returning the interfered resource unit to the sharing access point, the first shared access point allocates it to a second shared access point in the network that may be able to utilize it more effectively. The implementation of each step involves utilizing the wireless communication capabilities of the first shared access point, coordinating with the sharing access point, adhering to the specific protocol or standard being used, and ensuring proper timing and synchronization within the wireless network.

In the context of methods 1700 and 1800, an “access point” refers to a wireless device that acts as a central hub or gateway for other wireless devices to connect to a wireless network, such as a Wi-Fi network. Access points manage and coordinate the communication between wireless devices within their coverage area.

In the method 1700, there are two types of access points: a sharing access point and a shared access point. The sharing access point is the access point that initially holds the transmit opportunity (TXOP) and has the authority to allocate a portion of its TXOP to other access points. The sharing access point sends the first trigger frame to allocate resources to the shared access point. The shared access point is the access point that receives a portion of the TXOP from the sharing access point. The shared access point is responsible for identifying any interfered resource units allocated to it and returning them to the sharing access point using the second trigger frame.

In the method 1800, there are three types of access points. Similar to method 1700, there is a sharing access point that is the access point that allocates a portion of its TXOP to other access points using the first trigger frame. The first shared access point is the access point that receives a portion of the TXOP from the sharing access point. However, in this case, the first shared access point determines a particular resource unit that is interfered with by one or more overlapping basic service sets (OBSS) at both the sharing access point and itself. The second shared access point is another access point in the wireless network to which the first shared access point allocates the interfered resource unit using the second trigger frame. The second shared access point is expected to be able to utilize the interfered resource unit more effectively.

In the context of the method 1800, the first shared access point transmits the second trigger frame to allocate the interfered resource unit to another shared access point (referred to as the second shared access point) in the wireless network.

However, there is a potential limitation compared to the case where the interfered resource unit is returned to the sharing AP (e.g., as in method 1700). When the first shared AP sends the interfered resource unit to another shared AP, there is no guarantee that the receiving shared AP can actually reuse or utilize the interfered resource unit effectively. This is because the interference conditions and availability of the resource unit may vary at different shared AP within the network.

However, a possible approach to mitigate this limitation it to assume that the first shared access point (referred to as the initial shared access point) has already identified a suitable second shared AP that can potentially use the interfered resource unit, then it can transmit the enhanced MU-RTS TXS frame to that specific shared AP.

Two strategies for the initial shared access point to find a suitable second shared access point include (1) a sequential approach, and (2) a concurrent approach.

Sequential approach: The initial shared AP sequentially searches for a specific shared AP within a candidate set of shared access points. It communicates with each candidate shared AP one by one until it finds a shared access point that can effectively utilize the interfered resource unit.

Concurrent approach: The initial shared AP concurrently communicates with multiple candidate shared access points to find a suitable shared AP that can use the interfered resource unit. This approach may involve sending the enhanced MU-RTS TXS frame to multiple shared AP simultaneously and waiting for their responses to determine the most appropriate shared AP to allocate the interfered resource unit.

The sequential and concurrent approaches aim to increase the chances of finding a suitable second shared AP that can effectively utilize the interfered resource unit, thereby optimizing the overall resource utilization and network performance.

It is important to note that the effectiveness of these approaches may depend on various factors, such as the interference conditions, the number and distribution of shared APs in the network, and the specific criteria used to determine the suitability of a shared access point for allocating the interfered resource unit.

In both methods 1700 and 1800, the access points work together to efficiently manage and allocate wireless resources, such as resource units, within the wireless network. They communicate and coordinate with each other using trigger frames to optimize the utilization of resources and mitigate the impact of interference, ultimately improving the overall performance of the wireless network.

The sharing access point acts as the central authority, distributing resources to the shared access points. The shared access points, in turn, are responsible for identifying and handling interfered resource units, either by returning them to the sharing access point or by allocating them to other shared access points in the network that can utilize them more effectively.

In the context of the methods 1700 and 1800, a “resource unit” refers to a specific portion of the available wireless resources that can be allocated to a device for communication within a wireless network. Resource units may be defined in terms of time, frequency, or a combination of both, depending on the specific wireless technology and standard being used.

In the case of IEEE 802.11ax (Wi-Fi 6) and newer standards, resource units are primarily based on the concept of OFDMA (Orthogonal Frequency Division Multiple Access). In OFDMA, the available frequency spectrum is divided into smaller sub-channels or tones, and these tones are grouped together to form resource units.

For example, in Wi-Fi 6, resource units can have different sizes, such as any of the following sizes:
26-tone RU: This is the smallest resource unit in Wi-Fi 6, consisting of 26 tones. It is suitable for low-bandwidth applications or for serving users with poor channel conditions.
52-tone RU: This resource unit is composed of 52 tones and provides a balance between throughput and the number of users that can be served simultaneously.
106-tone RU: This resource unit consists of 106 tones and offers higher throughput compared to the smaller RUs. It is suitable for users with good channel conditions or for applications requiring higher bandwidth.
242-tone RU: This is a larger resource unit that comprises 242 tones. It provides high throughput and is suitable for users with excellent channel conditions or for bandwidth-intensive applications.

In the methods 1700 and 1800, when the sharing access point allocates a portion of its TXOP to the shared access point(s), it does so by assigning specific resource units. The shared access point(s) can then use these allocated resource units for communication within the wireless network.

However, due to interference from overlapping basic service sets (OBSS) or other sources, some of the allocated resource units may become interfered with and unsuitable for effective communication. In such cases, the shared access point(s) can either return the interfered resource units to the sharing access point (e.g., as in method 1700) or allocate them to other shared access points that may be able to utilize them more effectively (e.g., as in method 1800).

By managing and allocating resource units dynamically and efficiently, the methods 1700 and 1800 aim to optimize the utilization of wireless resources, mitigate the impact of interference, and improve the overall performance of the wireless network. The granularity and flexibility provided by resource units allow for fine-grained resource allocation and adaptation to varying channel conditions and user requirements.

In some embodiments, a resource unit of the methods 1700 and 1800 can correspond to a 20 MHz subchannel through the concept of channel bonding and OFDMA (Orthogonal Frequency Division Multiple Access).

Channel bonding is a technique used in wireless networks to combine multiple adjacent frequency channels to create a wider channel, thereby increasing the available bandwidth. In Wi-Fi 6, for example, the total channel bandwidth can be 20 MHz, 40 MHz, 80 MHz, or 160 MHz, depending on the available spectrum and the capabilities of the devices.

When a 20 MHz subchannel is used as the basis for resource unit allocation, it means that the available bandwidth is divided into smaller 20 MHz-wide frequency blocks. Each of these 20 MHz subchannels can then be further divided into resource units using OFDMA.

For example, a resource unit can correspond to a 20 MHz subchannel in one of the following ways:
Channel Bonding: The total available bandwidth (e.g., 80 MHz) is split into multiple 20 MHz subchannels. For example, an 80 MHz channel can be divided into four 20 MHz subchannels.
OFDMA within each 20 MHz Subchannel: Within each 20 MHz subchannel, OFDMA is applied to create resource units. The available tones (subcarriers) within the 20 MHz subchannel are grouped together to form resource units of different sizes, such as 26-tone RU, 52-tone RU, 106-tone RU, or 242-tone RU.
Resource Unit Allocation: The sharing access point can allocate specific resource units within a 20 MHz subchannel to the shared access point(s). For example, the sharing access point may allocate two 106-tone RUs within a 20 MHz subchannel to a shared access point.
Communication using Resource Units: The shared access point(s) can then use the allocated resource units within the 20 MHz subchannel for communication with their associated stations or with other access points in the network.

By dividing the available bandwidth into 20 MHz subchannels and applying OFDMA within each subchannel, the wireless network can achieve finer granularity and more efficient resource allocation. This approach allows multiple devices to communicate simultaneously within the same 20 MHz subchannel by using different resource units, leading to improved spectral efficiency and overall network performance.

The use of 20 MHz subchannels as the basis for resource unit allocation provides flexibility and compatibility with legacy devices that may not support wider channel bandwidths. It also allows for more granular resource allocation and adaptability to varying channel conditions and user requirements within each 20 MHz subchannel.

Overall, the correspondence between resource units and 20 MHz subchannels enables effective utilization of the available wireless spectrum, supports multi-user communication, and enhances the efficiency and performance of the wireless network.

### CONCLUSION

Disclosed herein is an enhanced MU-RTS TXS frame, which is designed to facilitate the return of interfered Resource Units (RUs) at the shared AP side. In a C-TDMA scenario, where multiple APs coordinate their transmissions, the shared APs may encounter situations where the allocated RUs are affected by interference, rendering them unavailable for use.

By implementing the proposed enhanced MU-RTS TXS frame, the system enables the shared APs to efficiently communicate and return the unavailable RUs to either the sharing AP or another shared AP. This mechanism allows for the dynamic reallocation of interfered RUs, ensuring that they can be effectively utilized by other APs in the network.

The avoidance of resource waste is an advantage of using the proposed frame. By promptly returning the interfered RUs and reassigning them to other APs, the system can optimize the utilization of available resources. This efficient resource management leads to an increase in overall system throughput, as the RUs that would otherwise remain unused due to interference can now be productively employed by other APs.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed at a wireless device operating as a shared access point in a wireless network, the method comprising:
wirelessly receiving a first trigger frame sent by a sharing access point in the wireless network to allocate a portion of a transmit opportunity of the sharing access point to the shared access point;
identifying an interfered resource unit of a plurality of resource units allocated by the sharing access point to the shared access point;
generating a second trigger frame to return the interfered resource unit for use by the sharing access point, the second trigger frame indicating the interfered resource unit; and
wirelessly transmitting the second trigger frame to the sharing access point to return the interfered resource unit for use by the sharing access point.

2. The method of claim 1, wherein the second trigger frame comprises an identifier of the sharing access point, an indication of the interfered resource unit, and an allocation duration value.

3. The method of claim 2, wherein the second trigger frame comprises a user information subfield; and wherein the identifier of the sharing access point, the indication of the interfered resource unit, and the allocation duration value are part of the user information subfield.

4. The method of claim 2, further comprising:
determining the allocation duration value of the second trigger frame based on all of:
an allocation duration value of the first trigger frame,
a duration value for transmitting a clear-to-send frame,
an aSIFStime value, and
an expected duration value for transmitting the second trigger frame.

5. The method of claim 4, wherein the allocation duration value of the first trigger frame, the duration value for transmitting the clear-to-send frame, the aSIFStime value, and the expected duration value for transmitting the second trigger frame are each stored in a memory buffer at the shared access point.

6. The method of claim 4, further comprising:
determining the allocation duration value of the second trigger frame based on subtracting from the allocation duration value of the first trigger frame both: (a) the duration value for transmitting the clear-to-send frame plus the aSIFStime value, and (b) the expected duration value for transmitting the second trigger frame plus the aSIFStime value.

7. The method of claim 1, wherein the first trigger frame is formatted using a non-High Throughput (HT) Physical Protocol Data Unit (PPDU) format that allows the first trigger frame to be duplicated over a total available bandwidth.

8. A method performed at a wireless device operating as a first shared access point in a wireless network, the method comprising:
wirelessly receiving a first trigger frame sent by a sharing access point in the wireless network to allocate a portion of a transmit opportunity of the sharing access point to the first shared access point;
determining a particular resource unit, of a plurality of resource units allocated by the sharing access point to the first shared access point, that is interfered with by one or more overlapping basic service sets at both the sharing access point and the first shared access point;
generating a second trigger frame to forward the particular resource unit for use by a second shared access point in the wireless network, the second trigger frame indicating the particular resource unit; and
wirelessly transmitting the second trigger frame to the second shared access point to forward the particular resource unit for use by the second shared access point.

9. The method of claim 8, wherein the second trigger frame comprises an identifier of the second shared access point, an indication of the particular resource unit, and an allocation duration value.

10. The method of claim 9, wherein the second trigger frame comprises a user information subfield; and wherein the identifier of the second shared access point, the indication of the particular resource unit, and the allocation duration value are part of the user information subfield.

11. The method of claim 9, further comprising:
determining the allocation duration value of the second trigger frame based on all of:
an allocation duration value of the first trigger frame,
a duration value for transmitting a clear-to-send frame,
an aSIFStime value, and
an expected duration value for transmitting the second trigger frame.

12. The method of claim 11, wherein the allocation duration value of the first trigger frame, the duration value for transmitting the clear-to-send frame, the aSIFStime value, and the expected duration value for transmitting the second trigger frame are each stored in a memory buffer at the first shared access point.

13. The method of claim 11, further comprising:
determining the allocation duration value of the second trigger frame based on subtracting from the allocation duration value of the first trigger frame both: (a) the duration value for transmitting the clear-to-send frame plus the aSIFStime value, and (b) the expected duration value for transmitting the second trigger frame plus the aSIFStime value.

14. The method of claim 8, further comprising:
identifying, using a sequential approach or a concurrent approach, the second shared access point to which to forward the particular resource unit for use by the second shared access point from among a plurality of candidate shared access points in the wireless network.

15. A wireless device to function as a shared access point in a wireless network, the wireless device comprising:
a radio frequency transceiver;
a memory device storing a set of instructions; and
a set of one or more processors coupled to the memory device, wherein the set of instructions, when executed by one or more processors of the set of one or more processors, causes the sharing access point to perform:
wirelessly receiving a first trigger frame sent by a sharing access point in the wireless network to allocate a portion of a transmit opportunity of the sharing access point to the shared access point;
identifying an interfered resource unit of a plurality of resource units allocated by the sharing access point to the shared access point;
generating a second trigger frame to return the interfered resource unit for use by the sharing access point, the second trigger frame indicating the interfered resource unit; and
wirelessly transmitting the second trigger frame to the sharing access point to return the interfered resource unit for use by the sharing access point.

16. The wireless device of claim 15, wherein the second trigger frame comprises an identifier of the sharing access point, an indication of the interfered resource unit, and an allocation duration value.

17. The wireless device of claim 16, wherein the second trigger frame comprises a user information subfield; and wherein the identifier of the sharing access point, the indication of the interfered resource unit, and the allocation duration value are part of the user information subfield.

18. The wireless device of claim 16, wherein the set of instructions, when executed by one or more processors of the set of one or more processors, causes the shared access point to perform:
determining the allocation duration value of the second trigger frame based on all of:
an allocation duration value of the first trigger frame,
a duration value for transmitting a clear-to-send frame,
an aSIFStime value, and
an expected duration value for transmitting the second trigger frame.

19. The wireless device of claim 18, wherein the allocation duration value of the first trigger frame, the duration value for transmitting the clear-to-send frame, the aSIFStime value, and the expected duration value for transmitting the second trigger frame are each stored in a memory buffer at the shared access point.

20. The wireless device of claim 18, wherein the set of instructions, when executed by one or more processors of the set of one or more processors, causes the shared access point to perform:
determining the allocation duration value of the second trigger frame based on subtracting from the allocation duration value of the first trigger frame both: (a) the duration value for transmitting the clear-to-send frame plus the aSIFStime value, and (b) the expected duration value for transmitting the second trigger frame plus the aSIFStime value.

21. The wireless device of claim 15, wherein the first trigger frame is formatted using a non-High Throughput (HT) Physical Protocol Data Unit (PPDU) format that allows the first trigger frame to be duplicated over a total available bandwidth.

22. A wireless device to function as a first shared access point in a wireless network, the wireless device comprising:
a radio frequency transceiver;
a memory device storing a set of instructions; and
a set of one or more processors coupled to the memory device, wherein the set of instructions, when executed by one or more processors of the set of one or more processors, causes the first shared access point to perform:
wirelessly receiving a first trigger frame sent by a sharing access point in the wireless network to allocate a portion of a transmit opportunity of the sharing access point to the first shared access point;
determining a particular resource unit, of a plurality of resource units allocated by the sharing access point to the first shared access point, is interfered with by one or more overlapping basic service sets at both the sharing access point and the first shared access point;
generating a second trigger frame to forward the particular resource unit for use by a second shared access point in the wireless network, the second trigger frame indicating the particular resource unit; and
wirelessly transmitting the second trigger frame to the second shared access point to forward the particular resource unit for use by the second shared access point.

23. The wireless device of claim 22, wherein the second trigger frame comprises an identifier of the second shared access point, an indication of the particular resource unit, and an allocation duration value.

24. The wireless device of claim 23, wherein the second trigger frame comprises a user information subfield; and wherein the identifier of the second shared access point, the indication of the particular resource unit, and the allocation duration value are part of the user information subfield.

25. The wireless device of claim 23, wherein the set of instructions, when executed by one or more processors of the set of one or more processors, causes the first shared access point to further perform:
determining the allocation duration value of the second trigger frame based on all of:
an allocation duration value of the first trigger frame,
a duration value for transmitting a clear-to-send frame,
an aSIFStime value, and
an expected duration value for transmitting the second trigger frame.

26. The wireless device of claim 25, wherein the allocation duration value of the first trigger frame, the duration value for transmitting the clear-to-send frame, the aSIFStime value, and the expected duration value for transmitting the second trigger frame are each stored in a memory buffer at the first shared access point.

27. The wireless device of claim 25, wherein the set of instructions, when executed by one or more processors of the set of one or more processors, causes the first shared access point to further perform:
determining the allocation duration value of the second trigger frame based on subtracting from the allocation duration value of the first trigger frame both: (a) the duration value for transmitting the clear-to-send frame plus the aSIFStime value, and (b) the expected duration value for transmitting the second trigger frame plus the aSIFStime value.

28. The wireless device of claim 22, wherein the set of instructions, when executed by one or more processors of the set of one or more processors, causes the first shared access point to further perform:
identifying, network using a sequential approach or a concurrent approach, the second shared access point to which to forward the particular resource unit for use by the second shared access point from among a plurality of candidate shared access points in the wireless.
